(19) United States
(12) Patent Application Publication
(10) Pub. No.: US 2013/0224648 A1
(43) Pub. Date: Aug. 29, 2013

(54) ELECTROSTATIC IMAGE DEVELOPING TONER PARTICLES AND DEVELOPER

(71) Applicants: Takahiro Honda, Shizuoka (JP); Osamu Uchinokura, Shizuoka (JP); Junichi Awamura, Shizuoka (JP); Satoshi Ogawa, Nara (JP); Satoshi Kojima, Shizuoka (JP); Teruki Kusahara, Shizuoka (JP); Daisuke Inoue, Shizuoka (JP); Daisuke Ito, Shizuoka (JP); Tsuneyasu Nagatomo, Shizuoka (JP); Masaki Watanabe, Shizuoka (JP)

(72) Inventors: Takahiro Honda, Shizuoka (JP); Osamu Uchinokura, Shizuoka (JP); Junichi Awamura, Shizuoka (JP); Satoshi Ogawa, Nara (JP); Satoshi Kojima, Shizuoka (JP); Teruki Kusahara, Shizuoka (JP); Daisuke Inoue, Shizuoka (JP); Daisuke Ito, Shizuoka (JP); Tsuneyasu Nagatomo, Shizuoka (JP); Masaki Watanabe, Shizuoka (JP)

(21) Appl. No.: 13/883,859

(22) PCT Filed: Nov. 9, 2011
(86) PCT No.: PCT/JP2011/076340

§ 371 Date: May 7, 2013

(30) Foreign Application Priority Data
Nov. 9, 2010 (JP) 2010-250576
Sep. 12, 2011 (JP) 2011-198227

(51) Int. Cl. G03G 9/087

(52) U.S. Cl. CPC G03G 9/08755
USPC 430/109.4

(57) ABSTRACT

Electrostatic image developing toner particles including: a crystalline polyester resin; a non-crystalline polyester resin; a releasing agent; and a colorant, wherein the electrostatic image developing toner particles have a glass transition temperature of 40° C. to 60° C. where the glass transition temperature is measured with a differential scanning calorimeter (DSC), and wherein the electrostatic image developing toner particles have an adhesive force between the toner particles of 1.4 mN to 2.2 mN where the adhesive force between the toner particles is measured after the electrostatic image developing toner particles have been stored at 50° C.

### TECHNICAL FIELD

The present invention relates to an electrostatic image developing toner and a developer.

### BACKGROUND ART

On the recent market, electrostatic image developing toners have been required to have a smaller particle diameter for outputting images of higher quality and to have an improved low-temperature fixability for energy saving.

The conventional kneading pulverizing method has a difficulty in producing electrostatic image developing toner particles (hereinafter also referred to simply as “toner particles”) having a small particle diameter. The toners produced by the kneading pulverizing method pose various problems that they are indefinite in shape, have a broad particle size distribution, and require high energy for being fixed. They crack on the interface of a releasing agent (wax) through pulverization and thus, have a large amount of wax present on the toner surface. Although the toners have a satisfactory releasing effect by virtue of the wax, the toners tend to adhere to a carrier, a photoconductor and a blade. The properties of such toners are not satisfactory as a whole.

To overcome the above-described problems the kneading pulverizing method has, toner production methods based on the polymerization method have been proposed. The toners produced by the polymerization method are easily made to have a smaller particle diameter. In addition, they have a sharper particle size distribution than that of the toners produced by the pulverizing method. Furthermore, it is possible for each toner particle to encapsulate wax.

As a toner production method based on the polymerization method, there has been disclosed a method for producing a toner having a practical sphericity of 0.90 to 1.00. In this method, the toner is produced from an elongation reaction product of a urethane-modified polyester serving as a toner binder, for the purpose of improving the toner in flowability, low-temperature fixability and hot offset resistance (see, for example, PTL 1).

Besides, there has been disclosed a method for producing a toner excellent in all of heat resistant storage stability, low-temperature fixability and hot offset resistance. The toner produced with this method has a small particle diameter to be excellent in flowability as powder and transferability (see, for example, PTLs 2 and 3).

In addition, there has been disclosed a method for producing a toner including an aging step for producing a toner binder having a stable molecular weight distribution and achieving a favorable balance between low-temperature fixability and hot offset resistance (see, for example, PTLs 4 and 5).

Furthermore, there has been disclosed a method in which a crystalline polyester is introduced into a toner with the polymerization method in order to improve the toner in low-temperature fixability. One preparation method for a dispersion liquid of the crystalline polyester has been disclosed in PTL 6 as a method for preparing the dispersion liquid using a solvent for phase separation. This method can prepare a dispersion liquid containing coarse particles with a dispersion diameter of several tens micrometers to several hundreds micrometers, but cannot prepare a dispersion liquid containing particles with a volume average particle diameter of 1.0 μm or less usable for a toner. Also, in order to make the dispersion diameter of the crystalline polyester smaller, PTL 7 describes an attempt where the crystalline polyester only is mixed with a solvent and the resultant mixture is increased or decreased in temperature to obtain the dispersion liquid containing the crystalline polyester with a smaller particle diameter. However, the dispersion state is not stable, which is not satisfactory.

### CITATION LIST

### Patent Literature

PTL 1: Japanese Patent Application Laid-Open (JP-A) No. 11-133665
PTL 2: JP-A No. 2002-287400
PTL 3: JP-A No. 2002-351143
PTL 4: Japanese Patent (JP-B) No. 2579150
PTL 5: JP-A No. 2001-158819
PTL 6: JP-A No. 08-176310
PTL 7: JP-A No. 2005-15589

### SUMMARY OF INVENTION

### Technical Problem

The present invention has been made under such circumstances, and aims to solve the problems pertinent in the art and achieve the following objects.

Specifically, an object of the present invention is to provide an electrostatic image developing toner (developer) containing at least a crystalline polyester and a non-crystalline polyester as binder resin components and can suppress formation of loosely aggregated matter (hereinafter referred to as “loose aggregates”) in the developing device which causes formation of abnormal images.

### Solution to Problem

The electrostatic image developing toner particles and developer of the present invention have technical features described in the following <1> to <8> to solve the above problems.

<1> Electrostatic image developing toner particles including:

a crystalline polyester resin;

a non-crystalline polyester resin;

a releasing agent; and

a colorant,

wherein the electrostatic image developing toner has a glass transition temperature of 40° C. to 60° C. where the glass transition temperature is measured with a differential scanning calorimeter (DSC), and

wherein the electrostatic image developing toner has an adhesive force between the toner particles of 1.4 mN to 2.2 mN where the adhesive force between the toner particles is measured after the electrostatic image developing toner particles have been stored at 50° C.

<2> The electrostatic image developing toner particles according to <1>, wherein the adhesive force between the toner particles is 1.4 mN to 2.0 mN.

<3> The electrostatic image developing toner particles according to <1> or <2>, wherein the crystalline polyester resin has a melting point of 60° C. to 80° C.

<4> The electrostatic image developing toner particles according to any one of <1> to <3>, wherein the electrostatic image developing toner particles are obtained by the method including:

dispersing, in an aqueous medium, an oil phase containing the crystalline polyester resin and the non-crystalline polyester resin in an organic solvent, to thereby obtain an O/W dispersion liquid; and

removing the organic solvent from the O/W dispersion liquid.

<5> The electrostatic image developing toner particles according to <4>, wherein the oil phase further contains a binder resin precursor.

<6> The electrostatic image developing toner particles according to <4>, wherein the oil phase contains a binder resin precursor formed of a modified polyester resin and the aqueous medium contains a dispersing agent, and wherein the electrostatic image developing toner particles are obtained by the method including:

dissolving, in the oil phase, a compound capable of elongating or crosslinking with the binder resin precursor;

dispersing, in the aqueous medium, the oil phase in which the compound has been dissolved, to thereby obtain a dispersion liquid;

allowing the binder resin precursor and the compound to undergo crosslinking reaction or elongating reaction or both of the crosslinking reaction and the elongating reaction in the dispersion liquid; and

removing the organic solvent from the dispersion liquid.

<7> The electrostatic image developing toner particles according to <1>, wherein the electrostatic image developing toner is obtained by the method including:

dispersing the crystalline polyester resin, and the non-crystalline polyester resin, respectively in separate aqueous media to emulsify the crystalline polyester resin and the non-crystalline polyester resin as crystalline polyester resin particles, and non-crystalline polyester resin particles, respectively;

mixing together the crystalline polyester resin particles, the non-crystalline polyester resin particles, a wax dispersion liquid in which the releasing agent is dispersed, and a colorant dispersion liquid in which the colorant is dispersed, to thereby prepare an aggregated particle dispersion liquid in which aggregated particles are dispersed;

heating the aggregated particle dispersion liquid to a temperature that is equal to or higher than a melting point of the crystalline polyester resin particles and that is equal to or higher than a melting point of the non-crystalline polyester resin particles, to thereby fuse and cohere the aggregated particles to form toner particles; and

washing the toner particles.

<8> A developer including:

the electrostatic image developing toner particles according to any one of <1> to <7>.

### Advantageous Effects of Invention

The present invention can provide an electrostatic image developing toner and a developer that exhibit both excellent low-temperature fixability and excellent developing stability even when they are used in a high-speed, full-color image forming apparatus.

### DESCRIPTION OF EMBODIMENTS

### (Electrostatic Image Developing Toner Particles)

An electrostatic image developing toner particles of the present invention contains at least a crystalline polyester resin (a binder resin component), a non-crystalline polyester resin (a binder resin component), a releasing agent and a colorant; and, if necessary, further contains other ingredients.

The electrostatic image developing toner particles have a glass transition temperature of 40° C. to 60° C. where the glass transition temperature is measured with a differential scanning calorimeter (DSC). In addition, the electrostatic image developing toner particles have an adhesive force between the toner particles of 1.4 mN to 2.2 mN where the adhesive force between the toner particles is measured after the electrostatic image developing toner particles have been stored at 50° C. The electrostatic image developing toner particles of the present invention will next be described in more detail.

Notably, since the below-described embodiments are preferred embodiments of the present invention, technically preferable limitations are imposed on them. However, the scope of the present invention is not construed as being limited to these embodiments, unless there is some description of limiting the present invention.

The electrostatic image developing toner particles (hereinafter also referred to simply as “electrostatic image developing toner,” “toner particles” or “toner”) of the present invention contains at least (as a thermoplastic resin) a crystalline polyester resin, a non-crystalline polyester resin, a releasing agent and a colorant. After the toner particles have been stored at 50° C. for 1.5 hours, the adhesive force between the toner particles is 1.4 mN to 2.2 mN, preferably 1.4 mN to 2.0 mN.

Also, after the toner particles have been stored at 50° C. for 1.5 hours, the adhesive force between the toner particles is more preferably 1.6 mN to 1.9 mN.

The adhesive force between the toner particles is susceptible to the surface composition of the toner particles. In the toner stored at ambient temperature, the adhesive force between toner particles tends to be higher when the wax and the crystalline polyester (i.e., adhesive ingredients) are located near the toner surface. In particular, the adhesive force between particles becomes considerably high, when the crystalline polyester and the non-crystalline polyester becomes in the partially compatible state during the toner production process thereby forming an adhesive ingredient which is then located near the toner surface.

Meanwhile, when a toner or a copier or printer containing the toner is exposed to high-temperature conditions, there is a problem in quality that the mass of the toner is attached to an output image to form an abnormal image (black spots or meteor-like streaks). This phenomenon occurs through the following mechanism: toner particles form loosely aggregated matter (loose aggregates) when heat is applied to the toner contained in the toner bottle, and the formed loose aggregates pass through a toner supply path to the developer or photoconductor and finally to a recording paper sheet to form an abnormal image.

The present inventors have found that the formation of the abnormal image is clearly related to the adhesive force between the toner particles after storage at a high temperature for a certain time and that a toner whose adhesive force between the toner particles falls within a desired range found in the present invention does not form such abnormal image.

The case where the adhesive force between the toner particles measured after the toner particles have been stored at 50° C. for 1.5 hours is less than 1.4 mN means that there exists a large amount of compatible components of the crystalline polyester and the non-crystalline polyester (i.e., adhesive ingredients) near the surfaces of the toner particles at ambient temperature. In this case, the adhesive ingredients stick to each other to form loose aggregates after the toner particles have been stored at 50° C. for 1.5 hours. As a result, the adhesive force between the toner particles becomes small after storage at high temperatures; however, the toner having an adhesive force between the toner particles of less than 1.4 mN forms abnormal images.

Meanwhile, the case where the adhesive force between the toner particles after storage at 50° C. for 1.5 hours is more than 2.2 mN means that there exists a small amount of compatible components of the crystalline polyester and the non-crystalline polyester (i.e., adhesive ingredients) near the surfaces of the toner particles at ambient temperature. In this case, there occurs no problem of forming the above-described abnormal images. However, similar to the compatible components of the crystalline polyester and the non-crystalline polyester, the amount of the wax (i.e., an adhesive ingredient) is also small, degrading offset resistance.

In order to adjust the adhesive force between the toner particles measured after the toner particles have been stored at 50° C. for 1.5 hours to fall within a desired range so that the loose aggregates do not cause the formation of abnormal images or the degradation of offset resistance, the present inventors have found that the adhesive force between the toner particles can be adjusted in the following manner. Specifically, for example, the dispersion conditions of the crystalline polyester and the non-crystalline polyester in the production process are controlled so as to prevent the crystalline polyester and the non-crystalline polyester from being in the compatible state; or the crystalline polyester and the non-crystalline polyester in the compatible state are heated at a temperature near the melting point of the crystalline polyester (annealing treatment) to thereby recrystallize the crystalline polyester.

### —Method for Measuring Adhesive Force Between the Toner Particles—

Here, a method for measuring the adhesive force between the toner particles is described below.

### (1) Preparation of Toner Sample

In an experimental laboratory controlled at 25° C. and 55% RH, 15 g of a toner is weighed and placed in a 50 cm³ sample bottle (e.g., trade name “SV-50,” product of NICHIDEN-RIKA GLASS CO., LTD.) and then the sample bottle is closed with a cap. The sample bottle is shaken at 2.5 S⁻¹ for 5 min by means of YAYOI shaker (model: YS-LD, product of YAYOI CO., LTD.). Here, the shaker is adjusted so that its support moves forward by 15 degrees and backward by 20 degrees when regarding the directly above position (vertical) of the shaker as 0 degrees. The sample bottle is fastened to a fastening holder attached to the end of the support (the cap of the sample bottle is fastened to the center of the support on its extension). After shaking, the sample bottle is carefully taken out so that the compacted toner is not broken.

Next, the sample bottle closed with the cap is stored in a high-temperature bath controlled at 50° C. or an environmental chamber controlled at 50° C. (e.g., “THERMALSTREAMT APS-200LLKP-D,” product of ORION Co.) for 1.5 hours. After storage, the toner (sample bottle) is cooled for 30 min or longer and then used as a measurement sample.

### (2) Measurement of Adhesive Force

The measurement sample obtained in (1) above is measured for adhesive force under the following conditions. The below-described measuring apparatus is generally used for measuring the surface tension and dynamic contact angle of a liquid sample. However, the present inventors have found that this measuring apparatus can be used to measure the adhesive force between the toner particles simply and with good reproducibility in the following manner: a powder (toner) sample is used instead of a liquid sample; a thin layer of toner is formed on a surface of a platinum plate in the powder sample; and the maximum tension measured when the platinum plate is removed is obtained.

Apparatus: dynamic contact angle/surface tension measuring apparatus DCA-100 (product of ORIENTECH CO., LTD.)

Data processing system: data processing system for general-purpose tester MSAT0001/0006 (product of A & D Company)

Sample carrier: platinum plate (10 mm×25 mm×0.1 mm)

### [Condition Setting of Apparatus]

### Load Cell:

rating: 10 gf
range: 4% rating
autorange: present
cycle time: once

### Cycle:

travel amount: 15 mm
velocity: 2 mm/min
wait time: 0

### [Condition Setting of Analysis]

### Basic Analysis Conditions;

item tested: surface tension
immersion starting point: 0.01 gf
density of liquid (powder): 1.2 g/cm³

The maximum tension is obtained as the unit “dyn/cm” in this application. Here, the obtained value is converted to a value as an SI unit. Then, the thus-converted value and the plate area are multiplied to each other to obtain a value as “mN,” which is used as a unit of the adhesive force between particles. The measurement is performed three times under the above conditions. The measured three values are averaged and the obtained average value is used as the adhesive force between the toner particles.

The electrostatic image developing toner of the present invention has a glass transition temperature of 40° C. to 60° C., preferably 45° C. to 55° C.

The glass transition temperature thereof is lower than 40° C., the formed toner is solidified in a toner bottle upon continuous image printing under high-temperature conditions in, for example, summer, failing to output images in some cases. Whereas when the glass transition temperature thereof exceeds 60° C., there may be degradation in low-temperature fixability.

### —Method for Measuring Glass Transition Temperature—

The glass transition temperature was measured in the following manner using a DSC system (differential scanning calorimeter) (“Q-200,” product of TA INSTRUMENTS Co.). First, about 5.0 mg of a resin (sample toner) was precisely weighed and placed in a sample container made of aluminum; the sample container was placed on a holder unit; and the holder unit was set in an electric furnace. Next, in a nitrogen atmosphere (flow rate: 50 mL/min), the sample was heated from 20° C. to 150° C. under the following conditions: temperature increasing rate: 1° C./min, temperature modulation cycle: 60 sec, temperature modulation amplitude: 0.159° C.; and then, was cooled from 150° C. to 0° C. at a temperature decreasing rate of 10° C./min. In this manner, a DSC curve was measured with the differential scanning calorimeter “Q-200” (product of TA INSTRUMENTS Co.). In the obtained DSC curve, the endothermic peak in the first elevation of temperature was selected to determine a temperature width of a region distant from the baseline by ⅓ the distance from the baseline to the top of the endothermic peak.

### <Crystalline Polyester Resin>

### —Effects of Crystalline Polyester Resin—

The crystalline polyester resin contained in the electrostatic image developing toner of the present invention has high crystallinity and thus exhibits such a hot melt property that the viscosity is rapidly decreased in the vicinity of a temperature at which fixing is initiated. That is, the present inventors have found that use of this crystalline polyester resin provides a toner having both a good heat resistant storage stability and a good low-temperature fixability, since the crystalline polyester resin exhibits a good heat resistant storage stability due to its crystallinity immediately before melting is initiated and is rapidly decreased in viscosity (sharp melt property) for fixing at a temperature at which melting is initiated. In addition, the present inventors have found that the toner containing this crystalline polyester resin has a suitable difference between the lower limit of the fixing temperature and the temperature at which hot offset occurs (i.e., a release range).

### —Crystalline Polyester Resin—

The melting point of the crystalline polyester resin used in the present invention is not particularly limited and may be appropriately selected depending on the intended purpose. It is preferably 60° C. to 80° C., more preferably 65° C. to 75° C.

When the melting point thereof is lower than 60° C., similar to the case of the above-described Tg of the toner, the formed toner is solidified in a toner bottle upon continuous image printing under high-temperature conditions in, for example, summer, failing to output images in some cases. Whereas when the melting point thereof exceeds 80° C., there may be degradation in low-temperature fixability.

### —Method for Measuring Melting Point of Crystalline Polyester Resin—

The melting point of the crystalline polyester resin can be measured from a DSC curve obtained using the DSC system in the same manner as in the above-described measurement of the glass transition temperature.

Specific examples of the crystalline polyester resin suitably usable in the present invention include crystalline polyester resins which are synthesized using an alcohol component, such as saturated aliphatic diol compounds having 2 to 12 carbon atoms; e.g., 1,4-butanediol, 1,6-hexanediol, 1,6-octanediol, 1,8-octanediol, 1,10-decanediol, 1,12-dodecanediol and derivatives thereof, and an acid component, such as a dicarboxylic acid having 2 to 12 carbon atoms and a double bond (C═C double bond), or saturated dicarboxylic acids having 2 to 12 carbon atoms, particularly, fumaric acid, 1,4-butanedioic acid, 1,6-hexanedioic acid, 1,8-ocatnedioic acid, 1,10-decanedioic acid, 1,12-dodecanedioic acid and derivatives thereof.

In particular, the crystalline polyester resin is preferably synthesized with one C4-C12 saturated diol component selected from 1,4-butanediol, 1,6-hexanediol, 1,6-octanediol, 1,8-octanediol, 1,10-decanediol, 1,12-dodecanediol; and one C4-C12 saturated dicarboxylic acid selected from 1,4-butanedioic acid, 1,6-hexanedioic acid, 1,8-ocatnedioic acid, 1,10-decanedioic acid and 1,12-dodecanedioic acid, since the obtained crystalline polyester resin has high crystallinity and also drastically changes in viscosity in the vicinity of the melting point thereof.

The crystallinity and the softening point of the crystalline polyester resin may be controlled, for example, by designing and employing a nonlinear polyester produced by condensation polymerization using an alcohol component to which, further, a trihydric or higher polyhydric alcohol such as glycerin is added and an acid component to which, further, a trivalent or higher polycarboxylic acid such as trimellitic anhydride is added during the synthesis of the polyester.

The molecular structure of the crystalline polyester resin in the present invention may be confirmed, for example, by NMR measurement of the crystalline polyester resin in a solution or as a solid, as well as by measurement of the crystalline polyester resin using X-ray diffraction, GC/MS, LC/MS, and IR. For example, simply in the infrared absorption spectrum, the crystalline polyester resin having an absorption at wavelengths of 965 cm⁻¹±10 cm⁻¹ and 990 cm⁻¹±10 cm⁻¹, which is based on an out-of-plane bending vibration (δCH) of an olefin, is exemplified.

As a result of extensive studies conducted in view of the fact that a crystalline polyester resin having a sharp molecular weight distribution and having a low molecular weight is excellent in achieving low-temperature fixability and that the crystalline polyester resin containing a large amount of the component having a low molecular weight is poor in heat resistant storage stability, the crystalline polyester resin used in the present invention preferably satisfy the following relationship.

That is, the present inventors have found that the toner achieves both desired low-temperature fixability and desired heat resistant storage stability when the crystalline polyester resin has a weight average molecular weight Mw of 5,000 to 20,000, contains the component having a number average molecular weight Mn of 500 or lower in an amount of 0% to 2.5%, and contains the component having a number average molecular weight Mn of 1,000 or lower in an amount of 0% to 5.0% in terms of molecular weight distribution by GPC using o-dichlorobenzene soluble content. More preferably, the crystalline polyester resin contains the component having a number average molecular weight Mn of 500 or lower in an amount of 0% to 2.0% and contains the component having a number average molecular weight Mn of 1,000 or lower in an amount of 0% to 4.0%

The binder resin component preferably contains a binder resin precursor.

The electrostatic image developing toner of the present invention is preferably a toner obtained by dissolving or dispersing, in an organic solvent, at least a colorant, a releasing agent, a crystalline polyester resin, a non-crystalline polyester resin, a binder resin precursor of a modified polyester-based resin and other binder resin components, to thereby prepare an oil phase; dissolving, in the oil phase, a compound capable of being elongated and/or crosslinked with the binder resin precursor; dispersing the oil phase in an aqueous medium containing fine particles of a dispersing agent, to thereby prepare an emulsified dispersion liquid; allowing the binder resin precursor to undergo crosslinking reaction and/or elongation reaction in the emulsified dispersion liquid; and removing the organic solvent.

### <Binder Resin Precursor>

The binder resin precursor is preferably a binder resin precursor of a modified polyester-based resin. Examples thereof include polyester prepolymers modified with isocyanate, epoxy, etc. The binder resin precursor is elongated with a compound having an active hydrogen group-containing compound (e.g., amines), contributing to improvement of the difference between the lower limit of the fixing temperature and the temperature at which hot offset occurs (i.e., the release range).

The polyester prepolymer can be easily synthesized by reacting, with a polyester resin (base reactant), an isocyanating agent, an epoxidizing agent, etc. which are conventionally known.

Examples of the isocyanating agent include aliphatic polyisocyanates (e.g., tetramethylene diisocyanate, hexamethylene diisocyanate and 2,6-diisocyanatomethylcaproate); alicyclic polyisocyanates (e.g., isophorone diisocyanate and cyclohexylmethane diisocyanate); aromatic diisocyanates (e.g., tolylene diisocyanate and diphenylmethane diisocyanate); aromatic-aliphatic diisocyanate (e.g., α,α,α′,α′-tetramethylxylylene diisocyanate); isocyanurates; products obtained by blocking the above polyisocyanates with phenol derivatives, oxime and caprolactam; and mixtures thereof.

The epoxidizing agent is typified by epichlorohydrin, etc.

The ratio of the isocyanating agent to the polyester resin (base reactant) is generally 5/1 to 1/1, preferably 4/1 to 1.2/1, still more preferably 2.5/1 to 1.5/1, in terms of the equivalent ratio [NCO]/[OH] of the isocyanate group [NCO] to the hydroxyl group [OH] of the polyester resin (base reactant). When the ratio [NCO]/[OH] exceeds 5, the formed toner is degraded in low-temperature fixability. When the [NCO] is less than 1, the urea content of the polyester prepolymer is lowered, and the formed toner is degraded in hot offset resistance.

The amount of the isocyanating agent contained in the polyester prepolymer is generally 0.5% by mass to 40% by mass, preferably 1% by mass to 30% by mass, still more preferably 2% by mass to 20% by mass. When the amount thereof is less than 0.5% by mass, the formed toner is degraded in hot offset resistance, and also is difficult to have both desired heat resistant storage stability and desired low-temperature fixability. Whereas when the amount thereof exceeds 40% by mass, the formed toner is degraded in low-temperature fixability.

The number of isocyanate groups contained per molecule of the polyester prepolymer is generally 1 or more, preferably 1.5 to 3 on average, more preferably 1.8 to 2.5 on average. When the number thereof is less than 1 per molecule, the urea-modified polyester resin obtained through elongation reaction is decreased in molecular weight, and thus, the formed toner is degraded in hot offset resistance.

The binder resin precursor preferably has a weight average molecular weight of 1×10⁴ to 3×10⁵.

<Compound Capable of being Elongated or Crosslinked with Binder Resin Precursor>

Examples of the compound capable of being elongated or crosslinked with the binder resin precursor include active hydrogen group-containing compounds such as amines. Examples of the amines include diamine compounds, tri or higher polyamines, aminoalcohol compounds, aminomercaptan compounds, amino acids and compounds whose amino groups are blocked.

Examples of the diamine compounds include aromatic diamines (e.g., phenylenediamine, diethyltoluenediamine and 4,4′-diaminodiphenylmethane); alicyclic diamines (e.g., 4,4′-diamino-3,3′-dimethyldicyclohexylmethane, diaminecyclohexane and isophoronediamine); and aliphatic diamines (e.g., ethylenediamine, tetramethylenediamine and hexamethylenediamine).

Examples of the tri or higher polyamine include diethylenetriamine and triethylenetetramine.

Examples of the aminoalcohol compound include ethanolamine and hydroxyethylaniline.

Examples of the aminomercaptan compound include aminoethyl mercaptan and aminopropyl mercaptan.

Examples of the amino acid include aminopropionic acid and aminocaproic acid.

Examples of the amino-blocked compound include oxazolidine compounds and ketimine compounds derived from the amines and ketones (e.g., acetone, methyl ethyl ketone and methyl isobutyl ketone).

Among these amines, preferred are diamine compounds, mixtures of diamine compounds and a small amount of a polyamine compound, and ketimine compounds derived from the diamine compounds.

### <<Colorant>>

The colorant usable in the present invention may be any known dye or pigment. Examples thereof include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower, lithopone and mixtures thereof. The amount of the colorant contained in the toner is generally 1% by mass to 15% by mass, preferably 3% by mass to 10% by mass.

In the present invention, the colorant may be mixed with a binder resin to form a masterbatch. Examples of the binder resin which is used for producing a masterbatch or which is kneaded together with a masterbatch include the above-described modified or unmodified polyester resins; styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers); polymethyl methacrylates; polybutyl methacrylates; polyvinyl chlorides; polyvinyl acetates; polyethylenes; polypropylenes, polyesters; epoxy resins; epoxy polyol resins; polyurethanes; polyamides; polyvinyl butyrals; polyacrylic acid resins; rosin; modified rosin; terpene resins; aliphatic or alicyclic hydrocarbon resins; aromatic petroleum resins; chlorinated paraffins; and paraffin waxes. These may be used alone or in combination.

The masterbatch can be prepared by mixing/kneading a colorant with a resin for use in a masterbatch through application of high shearing force. Also, an organic solvent may be used for improving mixing between these materials. Further, the flashing method, in which an aqueous paste containing a colorant is mixed/kneaded with a resin and an organic solvent and then the colorant is transferred to the resin to remove water and the organic solvent, is preferably used, since a wet cake of the colorant can be directly used (i.e., no drying is required to be performed). In this mixing/kneading, a high-shearing disperser (e.g., three-roll mill) is preferably used.

### <Releasing Agent>

The releasing agent is preferably a wax having a melting point of 50° C. to 120° C.

Such a wax can effectively act as the releasing agent at the interface between a fixing roller and a toner, and thus, can improve hot offset resistance without applying onto the fixing roller a releasing agent such as oil.

Notably, the melting point of the wax is determined by measuring maximum endothermic peak using a TG-DSC system TAS-100 (product of Rigaku Corporation) which is a differential scanning calorimeter.

The below-listed materials can be used as the releasing agent.

Examples of waxes include vegetable waxes (e.g., carnauba wax, cotton wax, Japan wax and rice wax), animal waxes (e.g., bees wax and lanolin), mineral waxes (e.g., ozokelite and ceresine) and petroleum waxes (e.g., paraffin waxes, microcrystalline waxes and petrolatum).

Examples of waxes other than the above natural waxes include synthetic hydrocarbon waxes (e.g., Fischer-Tropsch waxes and polyethylene waxes); and synthetic waxes (e.g., ester waxes, ketone waxes and ether waxes).

Further examples include fatty acid amides such as 1,2-hydroxystearic acid amide, stearic amide, phthalic anhydride imide and chlorinated hydrocarbons; low-molecular-weight crystalline polymers such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group as a side chain.

### <Charge Controlling Agent>

The electrostatic image developing toner of the present invention may further contain a charge controlling agent, if necessary. The charge controlling agent may be any known charge controlling agent. Examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine active agents, metal salts of salicylic acid, and metal salts of salicylic acid derivatives.

Specific examples thereof include nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (these products are of ORIENT CHEMICAL INDUSTRIES CO., LTD); quaternary ammonium salt molybdenum complex TP-302 and TP-415 (these products are of Hodogaya Chemical Co., Ltd.); quaternary ammonium salt COPY CHARGE PSY VP 2038, triphenylmethane derivative COPY BLUE PR, quaternary ammonium salt COPY CHARGE NEG VP2036 and COPY CHARGE NX VP434 (these products are of Hoechst AG); LRA-901 and boron complex LR-147 (manufactured by Japan Carlit Co., Ltd.); copper phthalocyanine; perylene; quinacridone; azo pigments; and polymeric compounds having, as a functional group, a sulfonic acid group, carboxyl group, quaternary ammonium salt, etc.

The amount of the charge controlling agent contained is not determined flatly and is varied depending on the type of the binder resin used, on an optionally used additive, and on the toner production method used (including the dispersion method used). The amount of the charge controlling agent is preferably 0.1 parts by mass to 10 parts by mass, more preferably 0.2 parts by mass to 5 parts by mass, per 100 parts by mass of the binder resin. When the amount thereof is more than 10 parts by mass, the formed toner has too high chargeability, resulting in that the charge controlling agent exhibits reduced effects. As a result, the electrostatic force increases between the developing roller and the toner, decreasing the fluidity of the toner and forming an image with reduced color density. When the amount thereof is less than 0.1 parts by mass, the effects of the charge controlling agent are not be obtained satisfactorily. These charge controlling agent and release agent may be melt-kneaded together with a masterbatch or binder resin, and then dissolved or dispersed. Needless to say, they may be added to an organic solvent simultaneously with the masterbatch or binder resin, or may be fixed on the surfaces of the formed toner particles.

### <Non-Crystalline Polyester Resin>

In the present invention, a non-crystalline unmodified polyester resin (non-crystalline polyester resin) is used as a component of the binder resin. Notably, the unmodified polyester resin is preferably in the at least partially compatible state with a modified polyester resin obtained through crosslinking reaction and/or elongation reaction of a binder resin precursor containing a modified polyester-based resin. When they are in the at least partially compatible state, the formed toner can be increased in low-temperature fixability and hot offset resistance. Thus, preferably, the modified polyester resin and the unmodified polyester resin are similar in their constituent alcohol component and their constituent carboxylic acid component. The unmodified polyester resin may be the non-crystalline polyester resin used in the crystalline polyester dispersion liquid so long as the non-crystalline polyester resin is unmodified.

When the difference in acid value between the crystalline polyester and the non-crystalline polyester is 10 or greater, the crystalline polyester and the non-crystalline polyester are poor in compatibility and affinity, resulting in that the formed toner may be degraded in low-temperature fixability. In addition, the crystalline polyester tends to be exposed on the toner surface, resulting in that the formed toner may easily contaminate a developing portion and cause filming.

Notably, in addition to the above unmodified polyester resin, the urea-modified polyester resin may be used in combination with a polyester resin modified with a chemical bond other than the urea bond. For example, a urethane-modified polyester resin may be used in combination.

When the modified polyester resin (e.g., urea-modified polyester resin) is contained in the toner composition, the modified polyester resin can be produced by, for example, the one-shot method.

As an example, a method for producing the urea-modified polyester resin will be described.

First, a polyol and a polycarboxylic acid are heated to a temperature of 150° C. to 280° C. in the presence of a catalyst such as tetrabutoxy titanate or dibutyltin oxide. Subsequently, the formed water is removed under reduced pressure if necessary, to prepare a polyester having a hydroxyl group. Thereafter, the thus-prepared polyester is reacted with a polyisocyanate at a temperature of 40° C. to 140° C. to prepare a polyester prepolymer having an isocyanate group. Further, the thus-prepared polyester prepolymer is reacted with an amine at a temperature of 0° C. to 140° C. to prepare a urea-modified polyester resin.

This urea-modified polyester resin preferably has a number average molecular weight of 1,000 to 10,000, more preferably 1,500 to 6,000.

Notably, a solvent may be used if necessary, when the hydroxyl group-containing polyester resin is reacted with the polyisocyanate and when the isocyanate group-containing polyester prepolymer is reacted with the amine.

Examples of the solvent include those inert with respect to an isocyanate group, such as aromatic solvents (e.g., toluene and xylene), ketones (e.g., acetone, methyl ethyl ketone and methyl isobutyl ketone), esters (e.g., ethyl acetate), amides (e.g., dimethylformamide and dimethylacetamide) and ethers (e.g., tetrahydrofuran).

Notably, when the unmodified polyester resin is used in combination, it is produced in a manner similar to that performed in the above production for the hydroxyl group-containing polyester resin, and then is dissolved in and mixed with the solution obtained after completion of the production of the urea-modified polyester resin.

In the present invention, the binder resin contained in the oil phase may contain the crystalline polyester resin, the non-crystalline polyester resin, the binder resin precursor and the unmodified resin. In addition, the binder resin may further contain other binder resin components than the above resins. The binder resin preferably contains a polyester resin. The amount of the polyester resin contained is preferably 50% by mass or more. When the amount of the polyester resin is less than 50% by mass, the formed toner may be decreased in low-temperature fixability. It is particularly preferred that all the binder resin components be polyester resins.

Notably, examples of the binder resin component other than the polyester resins include styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic acid ester copolymers); polymethyl methacrylates; polybutyl methacrylates; polyvinyl chlorides; polyvinyl acetates; polyethylenes; polypropylenes; epoxy resins; epoxy polyol resins; polyurethane resins; polyamide resins; polyvinyl butyrals; polyacrylic acid resins; rosin; modified rosin; terpene resins; aliphatic or alicyclic hydrocarbon resins; aromatic petroleum resins; chlorinated paraffins; and paraffin waxes.

### <<Production of Toner in Aqueous Medium>>

The aqueous medium used in the present invention may be water alone or a mixture of water and a water-miscible solvent. Examples of the water-miscible solvent include alcohols (e.g., methanol, isopropanol and ethylene glycol), dimethylformamide, tetrahydrofuran, cellosolves (e.g., methyl cellosolve) and lower ketones (e.g., acetone and methyl ethyl ketone).

The toner materials forming toner particles; e.g., a binder resin precursor, a colorant, a releasing agent, a crystalline polyester dispersion liquid, a charge controlling agent and an unmodified polyester resin, may be mixed together in an aqueous medium when forming dispersoids. Preferably, these toner materials are mixed together in advance, and the resultant mixture is added to an aqueous medium for dispersion. Also, in the present invention, the other toner materials, such as the colorant, the releasing agent and the charge controlling agent, are not necessarily added to the aqueous medium before particle formation, and they may be added thereto after particle formation. For example, the colorant may be added by a known dying method to the particles containing no colorant.

The dispersion method is not particularly limited. There can be used known dispersers employing, for example, low-speed shearing, high-speed shearing, friction, high-pressure jetting and ultrasonic wave. In order for the dispersoids to have a particle diameter of 2 μm to 20 μm, a high-speed shearing disperser is preferably used. In use of the high-speed shearing disperser, the rotating speed is not particularly limited and is generally 1,000 rpm to 30,000 rpm, preferably 5,000 rpm to 20,000 rpm. Also, the dispersion time is not particularly limited and is generally 0.1 min to 60 min when a batch method is employed. The temperature during dispersion is generally 0° C. to 80° C. (in a pressurized state), preferably from 10° C. to 40° C.

The amount of the aqueous medium used is generally 100 parts by mass to 1,000 parts by mass, per 100 parts by mass of the toner components. When the amount is less than 100 parts by mass, the toner composition cannot be sufficiently dispersed, resulting in failure to form toner particles having a predetermined particle diameter. Meanwhile, use of the aqueous medium more than 1,000 parts by mass is economically disadvantageous. If necessary, a dispersing agent may be used. Use of the dispersing agent is preferred from the viewpoints of attaining a sharp particle size distribution and realizing a stable dispersion state.

For reacting the polyester prepolymer with an active hydrogen group-containing compound, the active hydrogen group-containing compound may be added to the aqueous medium for reaction before the toner composition is dispersed therein. Alternatively, the active hydrogen group-containing compound may be added to the aqueous medium after the toner composition has been dispersed therein, causing reaction from the interfaces between the formed particles. In this case, a modified polyester is formed preferentially on the surfaces of the toner particles from the polyester prepolymer, which can provide concentration gradient from the surface to the core of the particles.

Examples of a dispersing agent for emulsifying and dispersing, in aqueous liquid, the oil phase in which the toner composition has been dispersed include anionic surfactants such as alkylbenzenesulfonic acid salts, α-olefin sulfonic acid salts and phosphoric acid esters; cationic surfactants such as amine salts (e.g., alkyl amine salts, aminoalcohol fatty acid derivatives, polyamine fatty acid derivatives and imidazoline), and quaternary ammonium salts (e.g., alkyltrimethylammonium salts, dialkyl dimethylammonium salts, alkyl dimethyl benzyl ammonium salts, pyridinium salts, alkyl isoquinolinium salts and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine.

Also, a fluoroalkyl group-containing surfactant can exhibit its dispersing effects even in a small amount. Preferred examples of the fluoroalkyl group-containing anionic surfactant include fluoroalkyl carboxylic acids having 2 to 10 carbon atoms and metal salts thereof, disodium perfluorooctanesulfonylglutamate, sodium 3-[omega-fluoroalkyl(C6 to C11)oxy)-1-alkyl(C3 or C4) sulfonates, sodium 3-[omega-fluoroalkanoyl(C6 to C8)-N-ethylamino]-1-propanesulfonates, fluoroalkyl(C11 to C20) carboxylic acids and metal salts thereof, perfluoroalkylcarboxylic acids(C7 to C13) and metal salts thereof, perfluoroalkyl(C4 to C12)sulfonate and metal salts thereof, perfluorooctanesulfonic acid diethanol amide, N-propyl-N-(2-hydroxyethyl)perfluorooctanesulfone amide, perfluoroalkyl(C6 to C10)sulfoneamidepropyltrimethylammonium salts, salts of perfluoroalkyl(C6 to C10)-N-ethylsulfonylglycin and monoperfluoroalkyl(C6 to C16) ethylphosphates.

Examples of commercially available products of the above-listed anionic surfactants include SURFLON S-111, S-112 and S-113 (these products are of Asahi Glass Co., Ltd.); FRORARD FC-93, FC-95, FC-98 and FC-129 (these products are of Sumitomo 3M Ltd.); UNIDYNE DS-101 and DS-102 (these products are of Daikin Industries, Ltd.); MEGAFACE F-110, F-120, F-113, F-191, F-812 and F-833 (these products are of Dainippon Ink and Chemicals, Inc.); EFTOP EF-102, 103, 104, 105, 112, 123A, 123B, 306A, 501, 201 and 204 (these products are of Tohchem Products Co., Ltd.); and FUTARGENT F100 and F150 (these products are of NEOS COMPANY LIMITED).

Examples of the fluoroalkyl group-containing cationic surfactant include fluoroalkyl group-containing primary, secondary or tertiary aliphatic compounds, aliphatic quaternary ammonium salts (e.g., perfluoroalkyl(C6 to C10)sulfonamide propyltrimethylammonium salts), benzalkonium salts, benzetonium chloride, pyridinium salts and imidazolinium salts. Examples of commercially available products of the above-listed cationic surfactants include SURFLON S-121 (product of Asahi Glass Co., Ltd.); FRORARD FC-135 (product of Sumitomo 3M Ltd.); UNIDYNE DS-202 (product of Daikin Industries, Ltd.); MEGAFACE F-150 and F-824 (these products are of Dainippon Ink and Chemicals, Inc.); EFTOP EF-132 (product of Tohchem Products Co., Ltd.); and FUTARGENT F-300 (product of Neos COMPANY LIMITED).

In addition, there can be used tricalcium phosphate, calcium carbonate, titanium oxide, colloidal silica, hydroxyapatite, and other poorly water-soluble inorganic dispersing agents.

Further, a polymeric protective colloid or water-insoluble fine organic particles may be used to stabilize dispersed droplets. Examples of the polymeric protective colloid or water-insoluble fine organic particles include acids (e.g., acrylic acid, methacrylic acid, α-cyanoacrylic acid, α-cyanomethacrylic acid, itaconic acid, crotonic acid, fumaric acid, maleic acid and maleic anhydride); hydroxyl group-containing acrylic monomers (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide), vinyl alcohol and ethers thereof (e.g., vinyl methyl ether, vinyl ethyl ether and vinyl propyl ether), esters formed between vinyl alcohol and a carboxyl group-containing compound (e.g., vinyl acetate, vinyl propionate and vinyl butyrate); acrylamide, methacrylamide, diacetone acrylamide and methylol compounds of thereof; acid chlorides (e.g., acrylic acid chloride and methacrylic acid chloride); nitrogen-containing compounds and nitrogen-containing heterocyclic compounds (e.g., vinyl pyridine, vinyl pyrrolidone, vinyl imidazole and ethyleneimine); polyoxyethylenes (e.g., polyoxyethylene, polyoxypropylene, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters and polyoxyethylene nonylphenyl esters); and celluloses (e.g., methyl cellulose, hydroxyethyl cellulose and hydroxypropyl cellulose).

When an acid- or alkali-soluble compound (e.g., calcium phosphate) is used as a dispersion stabilizer, the calcium phosphate used is dissolved with an acid (e.g., hydrochloric acid), followed by washing with water, to thereby remove it from the formed fine particles. Also, the calcium phosphate may be removed through enzymatic decomposition.

Alternatively, the dispersing agent used may remain on the surfaces of the toner particles. But, the dispersing agent is preferably removed through washing in terms of chargeability of the formed toner.

Furthermore, in order to decrease the viscosity of the toner composition, there can be used a solvent in which a modified polyester obtained through reaction of polyester prepolymers can be dissolved. Use of the solvent is preferred from the viewpoint of attaining a sharp particle size distribution. The solvent used is preferably a volatile solvent having a boiling point lower than 100° C., since solvent removal can be easily performed. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These solvents may be used alone or in combination.

Among them, aromatic solvents (e.g., toluene and xylene); and methylene chloride, 1,2-dichloroethane, chloroform and halogenated hydrocarbons (e.g., carbon tetrachloride) are preferred. The solvent is generally used in an amount of 0 parts by mass to 300 parts by mass, preferably 0 parts by mass to 100 parts by mass, more preferably 25 parts by mass to 70 parts by mass, per 100 parts by mass of the prepolymer. The solvent used is removed under normal or reduced pressure from the reaction mixture obtained after completion of elongation and/or crosslinking reaction.

The time required for elongation and/or crosslinking reaction depends, for example, on reactivity between a polyester prepolymer used and an active hydrogen group-containing compound used, and is generally 10 min to 40 hours, preferably 30 min to 24 hours. The reaction temperature is generally 0° C. to 100° C., preferably 10° C. to 50° C. If necessary, a known catalyst may be used. Specific examples thereof include tertiary amines (e.g., triethylamine) and imidazole.

Examples of the method for removing the organic solvent from the emulsified dispersion liquid include a method in which the entire reaction system is gradually increased in temperature to completely evaporate the organic solvent contained in the liquid droplets; and a method in which the emulsified dispersion liquid is sprayed in a dry atmosphere to completely remove and evaporate the water-insoluble organic solvent contained in the liquid droplets and the aqueous dispersing agent, whereby fine toner particles are formed. The dry atmosphere in which the emulsified dispersion liquid is sprayed generally uses heated gas (e.g., air, nitrogen, carbon dioxide and combustion gas), especially, gas flow heated to a temperature equal to or higher than the boiling point of the solvent used. By removing the organic solvent even in a short time using, for example, a spray dryer, a belt dryer or a rotary kiln, the resultant product has satisfactory quality.

When the emulsified or dispersed particles having a broad particle size distribution are subjected to washing and drying treatments as is, the washed and dried particles may be classified so as to have a desired particle size distribution.

Classification is performed by removing very fine particles using a cyclone, a decanter, a centrifugal separator, etc. in the liquid. Needless to say, classification may be performed on powder obtained after drying but is preferably performed in the liquid from the viewpoint of high efficiency. The thus-removed unnecessary fine particles or coarse particles may be returned to the kneading step, where the unnecessary particles can be used for forming toner particles. In this case, the unnecessary fine or coarse particles may be in a wet state.

The dispersing agent used is preferably removed from the obtained dispersion liquid to the greatest extent possible. Preferably, the dispersing agent is removed through the above-described classification.

The resultant dry toner particles may be mixed with other particles such as releasing agent fine particles, charge controlling agent fine particles and colorant fine particles, and also a mechanical impact may be applied to the mixture for immobilization or fusion of other particles on the toner surface, to thereby prevent the other particles from dropping off from the surfaces of the composite particles.

Specific examples of the method for applying a mixing or mechanical impact include a method in which an impact is applied to a mixture using a high-speed rotating blade, and a method in which an impact is applied by putting mixed particles into a high-speed air flow and accelerating the air speed such that the particles collide against one another or that the particles are crashed into a proper collision plate. Examples of apparatuses used in these methods include ANGMILL (product of Hosokawa Micron Corporation), an apparatus produced by modifying I-type mill (product of Nippon Pneumatic Mfg. Co., Ltd.) so that the pulverizing air pressure thereof is decreased, a hybridization system (product of Nara Machinery Co., Ltd.), a kryptron system (product of Kawasaki Heavy Industries, Ltd.) and an automatic mortar.

### <External Additive>

The electrostatic image developing toner of the present invention may contain an external additive for assisting its flowability, developability and chargeability.

Fine inorganic particles are preferably used as the external additive. The fine inorganic particles preferably have a primary particle diameter of 5 nm to 2 μm, more preferably 5 nm to 500 nm. Also, the specific surface area thereof as measured with the BET method is preferably 20 m²/g to 500 m²/g. The amount of the fine inorganic particles used is preferably 0.01% by mass to 5% by mass, more preferably 0.01% by mass to 2.0% by mass.

Specific examples of such inorganic microparticles include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride.

Besides, the fine polymer particles may be used as the external additive. Examples thereof include polystyrenes, methacrylic acid esters, acrylate copolymers, polycondensates (e.g., silicone, benzoguanamine and nylon) and polymer particles of thermosetting resins, which are produced through soap-free emulsion polymerization, suspension polymerization and dispersion polymerization.

A fluidizing agent is an agent improving hydrophobic properties through surface treatment, and is capable of inhibiting the degradation of flowability or chargeability under high humidity environment. Preferred examples of the fluidizing agent include silane coupling agents, silylation agents, silane coupling agents having a fluorinated alkyl group, organotitanate coupling agents, aluminum coupling agents, silicone oils, and modified silicone oils.

A cleanability improver for removing the developer remaining after transfer on a photoconductor or a primary transfer member (i.e., an intermediate transfer belt used in a so-called electrophotographic image forming apparatus) may be used as the external additive. Specific examples thereof include metal salts of fatty acids such as stearic acid (e.g., zinc stearate and calcium stearate) and fine polymer particles formed by soap-free emulsion polymerization, such as fine polymethylmethacrylate particles and fine polystylene particles. The fine polymer particles preferably have a relatively narrow particle size distribution. It is preferable that the volume average particle diameter thereof be 0.01 μm to 1 μm.

### <Inorganic Layered Mineral>

Also, the electrostatic image developing toner of the present invention may contain an inorganic layered mineral that is at least partially modified with an organic ion.

The term “inorganic layered mineral” refers to an inorganic mineral in which layers with a thickness of several nanometers are stacked on top of each other, and the description “modified with an organic ion” refers to introduction of an organic ion to between the layers. Such introduction is specifically described in, for example, JP-A Nos. 2003-515795, 2006-500605 and 2006-503313, and is called intercalation in a broad sense. Known inorganic layered minerals are, for example, smectite-group minerals (e.g., montmorillonite and saponite), kaoline-group minerals (e.g., kaolinite), magadiite and kanemite. Modified inorganic layered minerals have high hydrophobicity by virtue of their modified layered structure. That is, when an unmodified inorganic layered mineral is dispersed in an aqueous medium during granulation of toner particles, the unmodified inorganic layered mineral is transferred into the aqueous medium, resulting in failure to form deformed toner particles. However, when a modified inorganic layered mineral is used, toner particles can be readily deformed through granulation since the modified inorganic layered mineral has high hydrophobicity. In addition, the modified inorganic layered mineral are micronized and deformed during the production of toner and exist the surfaces of the toner particles in a particularly large amount, exhibiting a charge controlling function and contributing to low-temperature fixability. Here, the amount of the modified inorganic layered mineral contained in toner material is preferably 0.05% by mass to 5% by mass.

The modified inorganic layered mineral used in the present invention is preferably produced by modifying, with an organic cation, an inorganic layered mineral having a smectite structure as a basic crystal structure. Although a metal anion can be introduced into an inorganic layered mineral whose divalent metals have been partially substituted with a trivalent metal, the formed inorganic layered mineral has undesirably high hydrophilicity. Thus, at least part of metal anions thereof is preferably substituted with an organic anion.

By using an organic ion modifier, at least part of ions contained in the inorganic layered mineral can be modified with organic ions. Examples of the organic ion modifier include quaternary alkyl ammonium salts, phosphonium salts and imidazolium salts, with quaternary alkyl ammonium salts being preferred. Examples of the quaternary alkyl ammonium salt include trimethyl steary ammonium, dimethyl stearyl benzyl ammonium, dimethyl octadecyl ammonium and oleyl bis(2-hydroxyethyl)methyl ammonium.

Further examples of the organic ion modifier include sulfuric acid salts, sulfonic acid salts, carboxylic acid salts and phosphoric acid salts each having branched/unbranched or cyclic alkyl(C1 to C44), alkenyl(C1 to C22), alkoxy(C8 to C32), hydroxyalkyl(C2 to C22), ethylene oxide and/or propylene oxide. In particular, carboxylic acids having an ethylene oxide skeleton are preferred.

Through at least partially modifying the inorganic layered minerals with organic ions, the obtained modified inorganic layered mineral has a suitable hydrophobicity. Thus, when this modified inorganic layered mineral is incorporated into an oil phase containing a toner composition and/or toner composition precursor, the oil phase exhibits non-Newtonian viscosity, resulting in forming deformed toner particles. As mentioned above, the amount of the modified inorganic layered mineral contained in toner materials is preferably 0.05% by mass to 5% by mass.

The at least partially modified inorganic layered mineral can be appropriately selected. Examples thereof include montmorillonite, bentnite, hectorite, attapulgite, sepiolite and mixtures thereof. In particular, organic modified montmorillonite and bentnite are preferred, from the viewpoints of giving no adverse effects to characteristics of the formed toner, of allowing easy control of viscosity, and of attaining desired effects in even a small amount.

Examples of commercially available inorganic layered minerals at least partially modified with an organic cation include quaternium 18 bentnite such as Bentone 3, Bentone 38, Bentone 38V (these products are of Leox Co.), Thixogel VP (product of United Catalyst Co.), Clayton 34, Clayton 40 and Clayton XL (these products are of Southern Clay Products, Inc.); stearalkonium bentonite such as Bentone 27 (product of Leox Co.), Thixogel LG (product of United Catalyst Co.), Clayton AF and Clayton APA (these products are of Southern Clay Products, Inc.); and quaternium 18/benzalkonium bentonite such as Clayton HT and Clayton PS (these products are of Southern Clay Products, Inc.). Of these, Clayton AF and Clayton APA are particularly preferred. Meanwhile, inorganic layered minerals at least partially modified with an organic anion are particularly preferably produced by modifying DHT-4A (product of Kyowa Chemical Industry Co.) with an organic anion represented by the following General Formula (3). Examples of the compound represented by General Formula (3) include Hightenol 330T (product of Dai-ichi Kogyo Seiyaku Co.).

R₁(OR₂)nOSO₃M General Formula (3)

In General Formula (3), R₁ represents an alkyl group having 13 carbon atoms, R₂ represents an alkylene group having 2 to 6 carbon atoms, n is an integer of 2 to 10, and M represents a monovalent metal.

During the production of toner, use of the modified inorganic layered mineral with a suitable hydrophobicity allows a toner composition-containing oil phase to exhibit non-Newtonian viscosity, resulting in forming deformed toner particles.

<<Method for Dissolving or Recrystallizing Crystalline Polyester In or from Organic Solvent>>

The crystalline polyester is dissolved in or recrystallized from the organic solvent with the following method. Specifically, 10 g of the crystalline polyester and 90 g of the organic solvent are mixed together and stirred at 70° C. for 1 hour. The stirred solution is cooled at 20° C. for 12 hours to recrystallize the crystalline polyester. Separately, a filter paper No. 4 for KIRIYAMA funnel (product of Kiriyama glass Co.) is set to a KIRIYAMA funnel (product of Kiriyama glass Co.). Using the KIRIYAMA funnel, the above-recrystallized dispersion liquid of the crystalline polyester in the organic solvent is subjected to aspiration filtration with an aspirator, to thereby separate the organic solvent from the crystalline polyester. The thus-separated crystalline polyester is dried at 35° C. for 48 hours to thereby obtain recrystallized products of the crystalline polyester.

The electrostatic image developing of the present invention can be measured for volume average particle diameter (Dv) and number average particle diameter (Dn) as follows: a particle size analyzer (Multisizer III, product of Beckman Coulter Co.) is used with an aperture diameter being set to 100 μm, and the obtained values are analyzed with analysis software (Beckman Coulter Multisizer 3 Version 3.51.). Specifically, a 10% by mass surfactant (alkylbenzene sulfonate, Neogen SC-A, product of Daiichi Kogyo Seiyaku Co.) (0.5 mL) is added to a 100 mL-glass beaker, and a toner sample (0.5 g) is added thereto, followed by stirring with a microspartel. Subsequently, ion-exchange water (80 mL) is added to the beaker, and the obtained dispersion is dispersed with an ultrasonic wave disperser (W-113MK-II, product of Honda Electronics Co.) for 10 min. The resultant dispersion is measured using the above Multisizer III and, as a solution for measurement, Isoton III (product of Beckman Coulter Co.). The dispersion containing the toner sample is dropped so that the concentration indicated by the meter falls within a range of 8%±2%. Notably, in this method, it is important that the concentration is adjusted to 8%±2%, considering attaining measurement reproducibility with respect to the particle diameter. No measurement error is observed, so long as the concentration falls within the above range.

In the present invention, measurement of ultrafine toner particles can be performed the flow-type particle image analyzer FPIA-2100 (product of Sysmex Co.). The obtained measurements are analyzed the analysis software FPIA-2100 Data Processing Program for FPIA version 00-10. Specifically, a 10% by mass surfactant (alkylbenzene sulfonate, Neogen SC-A, product of Daiichi Kogyo Seiyaku Co.) (0.1 mL to 0.5 mL) is added to a 100 mL-glass beaker, and a toner sample (0.1 g to 0.5 g) is added thereto, followed by stirring with a microspartel. Subsequently, ion-exchange water (80 mL) is added to the beaker, and the obtained dispersion is dispersed with an ultrasonic wave disperser (product of Honda Electronics Co.) for 3 min. The resultant dispersion is measured with respect to the shape/distribution of toner using the FPIA-2100 until the toner density falls within a range of 5,000/μL to 15,000/μL. Notably, in this method, it is important that the toner density of the dispersion is adjusted to 5,000/μL to 15,000/μL, considering attaining measurement reproducibility with respect to the average circularity. In order for the toner density to fall within the above range, the conditions under which the dispersion is prepared must be modified; i.e., the amounts of a surfactant and toner added must be adjusted. The amount of the surfactant required varies depending on the hydrophobicity of the toner. Specifically, when it is added in a large amount, bubbles generated causes noise; whereas when it is added in a small amount, the toner surface cannot be provided with sufficient wettability and thus a sufficient dispersion state cannot be attained. Meanwhile, the amount of the toner added varies depending on the particle diameter thereof. Specifically, the toner with a small particle diameter must be added in a small amount, and the toner with a large particle diameter must be added in a large amount. For example, when the toner with a particle diameter of 3 μm to 7 μm is added in an amount of 0.1 g to 0.5 g, the toner density of the formed dispersion can be adjusted to 5,000 μL to 15,000/4.

<<Method for Producing a Toner when a Reactive, Modified Polyester is Used>>

In the present invention, a urea-modified polyester (UMPE), etc. can be obtained by reacting, with an amine (B), a reactive, modified polyester (e.g., an isocyanate group-containing polyester prepolymer (A)) in an aqueous medium. The method for stably forming dispersoids, in the aqueous medium, of modified polyester (e.g., urea-modified polyester) and reactive, modified polyester (e.g., prepolymer (A)) is, for example, a method in which toner components containing modified polyester (e.g., urea-modified polyester) and reactive, modified polyester (e.g., prepolymer (A)) are added to the aqueous medium where they are dispersed through application of shearing force. The reactive, modified polyester (e.g., prepolymer (A)) may be mixed with other toner components (hereinafter referred to as “toner materials”); e.g., a colorant, a releasing agent, a charge controlling agent and an unmodified polyester resin when forming dispersoids thereof in the aqueous medium. Preferably, the toner materials are previously mixed together before dispersed in the aqueous medium and then the resultant mixture is added to the aqueous medium where it is dispersed. Also, in the present invention, other toner materials, such as the colorant, releasing agent and charge controlling agent, are not necessarily added to the aqueous medium before particle formation, and they may be added thereto after particle formation. For example, the colorant may be added by a known dying method to the particles containing no colorant.

The dispersion method is not particularly limited. There can be used known dispersers employing, for example, low-speed shearing, high-speed shearing, friction, high-pressure jetting and ultrasonic wave. In order for the dispersoids to have a particle diameter of 2 μm to 20 μm, a high-speed shearing disperser is preferably used. In use of the high-speed shearing disperser, the rotating speed is not particularly limited and is generally 1,000 rpm to 30,000 rpm, preferably 5,000 rpm to 20,000 rpm. Also, the dispersion time is not particularly limited and is generally 0.1 min to 5 min when a batch method is employed. The temperature during dispersion is generally 0° C. to 150° C. (in a pressurized state), preferably from 40° C. to 98° C. The dispersion temperature is preferably higher since the dispersoids of the urea-modified polyester and prepolymer (A) are low in viscosity and easily dispersed.

The amount of the aqueous medium used is generally 50 parts by mass to 2,000 parts by mass, preferably 100 parts by mass to 1,000 parts by mass, per 100 parts by mass of the toner components containing polyesters such as the urea-modified polyester and prepolymer (A). When it is less than 50 parts by mass, the toner composition cannot be sufficiently dispersed, resulting in failure to form toner particles having a predetermined particle diameter. Meanwhile, use of the aqueous medium more than 2,000 parts by mass is economically disadvantageous. If necessary, a dispersing agent may be used. Use of the dispersing agent is preferred from the viewpoints of attaining a sharp particle size distribution and realizing a stable dispersion state.

In order for the oil phase containing the toner composition to be dispersed in a liquid containing water, various dispersing agents for emulsification and dispersion are used. Such dispersing agent includes surfactants, fine inorganic particle dispersing agents and fine polymer particle dispersing agents. The above-listed compounds are preferably used as these dispersing agents.

Besides, fine polymer particles were found to have the same effects as the inorganic dispersing agent. Examples of the fine polymer particles include MMA fine polymer particles of 1 μm and 3 μm, fine styrene particles of 0.5 μm and 2 μm, and styrene-acrylonitrile fine polymer particles of 1 μm (PB-200H (product of Kao Corporation), SGP (product of Soken Chemical & Engineering Co., Ltd.), Techno Polymer SB (product of SEKISUI PLASTICS CO. LTD.), SGP-3G (product of Soken Chemical & Engineering Co., Ltd.) and MICOR PEARL (product of SEKISUI FINE CHEMICAL CO., LTD.)).

A polymeric protective colloid may be used for stabilizing dispersed liquid droplets as a dispersing agent usable in combination with the above inorganic dispersing agent and fine polymer particles. Examples of the polymeric protective colloid include homopolymers and copolymers prepared using acids such as acrylic acid, methacrylic acid, α-cyanoacrylic acid, α-cyanomethacrylic acid, itaconic acid, crotonic acid, fumaric acid, maleic acid and maleic anhydride; hydroxyl group-containing (meth)acrylic monomers such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide; vinyl alcohols and ethers of vinyl alcohols such as vinyl methyl ether, vinyl ethyl ether and vinyl propyl ether; esters formed between vinyl alcohol and carboxyl group-containing compounds such as vinyl acetate, vinyl propionate and vinyl butyrate; acrylamide, methacrylamide, diacetoneacrylamide and methylol compounds thereof; acid chlorides such as acrylic acid chloride and methacrylic acid chloride; and compounds containing a nitrogen atom or a nitrogen-containing heterocyclic ring such as vinyl pyridine, vinyl pyrrolidone, vinyl imidazole and ethyleneimine. Further examples of the polymeric protective colloid include polyoxyethylene resins such as polyoxyethylenes, polyoxypropylenes, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters and polyoxyethylene nonylphenyl esters; and celluloses such as methyl cellulose, hydroxyethyl cellulose and hydroxypropyl cellulose.

The obtained emulsified dispersoids (reactants) are stirred and converged at a certain temperature range lower than the glass transition temperature of the resin and at a certain concentration range of the organic solvent to thereby form aggregated particles. The entire system is gradually increased in temperature with stirring like laminar airflow to remove the organic solvent (desolvation), whereby deformed toner particles can be produced. Notably, when an acid- or alkali-soluble compound such as calcium phosphate is used as a dispersing agent, the calcium phosphate used is dissolved with an acid such as hydrochloric acid, followed by washing with water, to thereby remove the calcium phosphate from the formed fine particles. Alternatively, the calcium phosphate may be removed therefrom through, for example, enzymatic decomposition.

When the dispersing agent is used, the dispersing agent may be allowed to remain on the surfaces of the toner particles.

Furthermore, in order to decrease the viscosity of dispersion liquid containing the toner components, there can be used a solvent in which polyesters such as a urea-modified polyester and prepolymer (A) can be dissolved. Use of the solvent is preferred from the viewpoint of attaining a sharp particle size distribution.

The solvent used is preferably a volatile solvent having a boiling point lower than 100° C., since solvent removal can be easily performed. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These solvents may be used alone or in combination. Among them, aromatic solvents (e.g., toluene and xylene); and methylene chloride, 1,2-dichloroethane, chloroform and halogenated hydrocarbons (e.g., carbon tetrachloride) are preferred.

The solvent is generally used in an amount of 0 parts by mass to 300 parts by mass, preferably 0 parts by mass to 100 parts by mass, more preferably 25 parts by mass to 70 parts by mass, per 100 parts by mass of prepolymer (A). When the solvent is used, it is removed under normal or reduced pressure from the reaction mixture obtained after completion of elongation and/or crosslinking reaction between modified polyester (prepolymer) and amine.

The time required for elongation and/or crosslinking reaction depends, for example, on reactivity between the isocyanate group-containing moiety of prepolymer (A) and the amine (B), but is generally 10 min to 40 hours, preferably 2 hours to 24 hours. The reaction temperature is generally 0° C. to 150° C., preferably 40° C. to 98° C. If necessary, a known catalyst may be used. Specific examples thereof include dibutyltinlaurate and dioctyltinlaurate. Notably, the amine (B) is used as the elongating agent and/or crosslinking agent.

In the present invention, prior to desolvation of the dispersion liquid (reaction mixture) having undergone elongation and/or crosslinking reaction, preferably, the dispersion liquid is stirred and converged at a certain temperature range lower than the glass transition temperature of the resin and at a certain concentration range of the organic solvent to thereby form aggregated particles, and the shapes of the aggregated particles are confirmed, followed by desolvating at 10° C. to 50° C. This stirring prior to the removal of the solvent (desolvation) allows toner particles to be deformed. The above conditions are not absolute conditions and thus, appropriate conditions have to be set.

When the concentration of the organic solvent is high during granulation, the emulsified liquid is decreased in viscosity, resulting in that the combined liquid droplets tend to be spherical. Whereas when the concentration of the organic solvent is low during granulation, each of the combined liquid droplets has high viscosity and does not become one complete particle; i.e., some liquid droplets are separated from the combined liquid droplet. Therefore, it is necessary to set optimum conditions. Also, the shapes of toner particles can be changed by appropriately setting conditions.

Besides, the shapes of toner particles can be changed by changing the amount of the inorganic layered mineral modified with organic ions (organic-modified inorganic layered mineral). The organic-modified inorganic layered mineral is preferably contained in an amount of 0.05% by mass to 10% by mass relative to the solid content of the dispersion liquid (solution).

When the amount of the organic-modified inorganic layered mineral is less than 0.05% by mass, the formed oil phase cannot have an intended viscosity, resulting in that the formed toner particles cannot have an intended shape. Even when the liquid droplets are combined together during stirring and converging, the intended combined particles cannot be obtained since the liquid droplets are low in viscosity. That is, the combined particles become spherical.

Whereas when the amount of the organic-modified inorganic layered mineral is more than 10% by mass, production suitability becomes poor. The liquid droplets are too high in viscosity and the combined particles cannot be formed. In addition, fixing performance is degraded.

Also, the ratio Dv/Dn of a toner; i.e., volume average particle diameter (Dv)/number average particle diameter (Dn) can be adjusted by mainly adjusting the viscosity of an aqueous layer, the viscosity of an oil layer, and properties and amount of fine resin particles. The Dv or Dn can be controlled by adjusting properties and amount of fine resin particles.

### <<Toner Production Method According to Emulsification Aggregation Fusion Method>>

The emulsification aggregation fusion method includes: dispersing the crystalline polyester resin, and the non-crystalline polyester resin, respectively in separate aqueous media to emulsify the crystalline polyester resin and the non-crystalline polyester resin as crystalline polyester resin particles, and non-crystalline polyester resin particles, respectively (hereinafter may be referred to as “emulsification step”); mixing together the crystalline polyester resin particles, the non-crystalline polyester resin particles, a separately provided wax dispersion liquid in which the releasing agent is dispersed, and a separately provided colorant dispersion liquid in which the colorant is dispersed, to thereby prepare an aggregated particle dispersion liquid in which aggregated particles are dispersed (hereinafter may be referred to as “aggregation step”); and heating the aggregated particle dispersion liquid, to thereby fuse the aggregated particles to form toner particles (hereinafter may be referred to as “fusion step”).

In the aggregation step, the aggregated particles are formed by heteroaggregation or the like. During the formation of the aggregated particles, an ionic surfactant having the opposite polarity to that of the aggregated particles, and/or a compound having one or more charges, such as a metal salt may be added for the purposes of stabilizing the aggregated particles, and controlling the particle diameters and/or particle size distribution of the aggregated particles. In the fusion step, the aggregated particle dispersion liquid is heated to a temperature that is equal to or higher than a melting point of the crystalline polyester resin particles and that is equal to or higher than a melting point of the non-crystalline polyester resin particles, to thereby fuse and cohere the aggregated particles to form toner particles.

Prior to the fusion step, a deposition step may be performed. The deposition step is adding and mixing a dispersion liquid of other fine particles to the aggregated particle dispersion liquid to uniformly deposit fine particles on surfaces of the aggregated particles to form deposited particles.

The fused particles formed by fusing in the fusing step exist as a color fused particle dispersion liquid in the aqueous medium. In a washing step, the fused particles are separated from the aqueous medium, at the same time as removing the impurities and the like mixed in each steps. The separated particles are then dried to thereby obtain an electrostatic image developing toner as a powder.

In the washing step, acidic water, or basic water in some cases, is added to the fused particles in an amount that is several times the amount of the fused particles, and the resultant is stirred, followed by filtrating the resultant to separate a solid component. To this, pure water is added in an amount that is several times the amount of the solid component, and the resultant is stirred, followed by filtration. This operation is repeated several times until the pH of the filtrate after filtration becomes about 7, to thereby obtain colored toner particles. In the drying step, the toner particles obtained in the washing step is dried at the temperature lower than the glass transition temperature of the toner particles. During the heating, dry air may be circulated, or heating is performed in the vacuumed condition, if necessary.

In the present invention, the fusing is performed by heating the aggregated particles at a temperature equal to or higher than the glass transition temperatures. In the case where the crystalline polyester resin and the non-crystalline polyester resin are used in combination, they become in the compatible state. Therefore, annealing has to be performed in the process of the toner production. The annealing can be performed before or during the washing step, or during or after the drying step.

Examples of the surfactant include anionic surfactants such as sulfuric acid esters, sulfonic acid salts, phosphoric acid esters and soap; cationic surfactants such as amine salts and quaternary ammonium salts; and nonionic surfactants such as polyethylene glycols, alkylphenolethyleneoxide adducts and polyhydric alcohols. Of these, ionic surfactants are preferred, with anionic or cationic surfactants being preferred. In the electrostatic image developing toner of the present invention, the cationic surfactants are advantageously used as the surfactant for dispersing the releasing agent, while the anionic surfactants have so strong dispersing capability that they can satisfactorily disperse the resin particles and colorant. The nonionic surfactants are preferably used in combination with the anionic surfactants or the cationic surfactants. The surfactants may be used or in combination.

Specific examples of the anionic surfactant include fatty acid soaps such as potassium laurate, sodium oleate and caster oil sodium salt; sulfuric acid esters such as octyl sulfate, lauryl sulfate, lauryl ether sulfate and nonylphenyl ether sulfate; sulfonic acid salts such as lauryl sulfonate, dodecylbenzene sulfonate, alkylnaphthalene sulfonate (e.g., triisopropylnaphthalene sulfonate and dibutylnaphthalene sulfonate), naphthalene sulfonate-formalin condensate, monooctylsulfosuccinate, dioctylsulfosuccinate, lauric acid amide sulfonate and oleic acid amide sulfonate; phosphoric acid esters such as lauryl phosphate, isopropyl phosphate and nonylphenyl ether phosphate; and sulfosuccinic acid salts such as dialkylsulfosuccinic acid salts (e.g., sodium dioctylsulfosuccinate) and 2-sodium lauryl sulfossucinate.

Specific examples of the cationic surfactant include amine salts such as lauryl amine hydrochloride, stearyl amine hydrochloride, oleyl amine acetate, stearyl amine acetate and stearylaminopropyl amine acetate; and quaternary ammonium salts such as lauryl trimethyl ammonium chloride, dilauryl dimethyl ammonium chloride, distearyl ammonium chloride, distearyl dimethyl ammonium chloride, lauryl dihydroxyethylmethyl ammonium chloride, oleyl bis(polyoxyethylene)methyl ammonium chloride, lauroyl aminopropyl dimethyl ethyl ammonium ethosulfate, lauroyl aminopropyl dimethyl hydroxyethyl ammonium perchlorate, alkylbenzene dimethyl ammonium chloride and alkyltrimethyl ammonium chloride.

Specific examples of the nonionic surfactant include: alkyl ethers such as polyoxyethylene octyl ether, polyoxyethylene lauryl ether, polyoxyethylene stearyl ether and polyoxyethylene oleyl ether; alkylphenyl ethers such as polyoxyethylene octylphenyl ether and polyoxyethylene nonylphenyl ether; alkyl esters such as polyoxyethylene laurate, polyoxyethylene stearate and polyoxyethylene oleate; alkyl amines such as polyoxyethylene laurylamino ether, polyoxyethylene stearylamino ether, polyoxyethylene oleylamino ether, polyoxyethylene soy-amino ether and polyoxyethylene beef tallow-amino ether; alkyl amides such as polyoxyethylene lauric acid amide, polyoxyethylene stearic acid amide and polyoxyethylene oleic acid amide; vegetable oil ethers such as polyoxyethylene caster oil ether and polyoxyethylene rapeseed oil ether; alkanol amides such as lauric diethanolamide, stearic diethanolamide and oleic diethanolamide; and sorbitan ester ethers such as polyoxyethylene sorbitan monolaurate, polyoxyethylene sorbitan monopalmitate, polyoxyethylene sorbitan monostearate and polyoxyethylene sorbitan monooleate.

The amount of the surfactant(s) contained in the dispersion liquid may be such an amount so as not to impede the effects of the present invention. The amount thereof is generally small. Specifically, in the dispersion liquid of the resin particles, the amount of the surfactant(s) is about 0.01% by mass to about 1% by mass, preferably 0.02% by mass to 0.5% by mass, more preferably 0.1% by mass to 0.2% by mass. When it is less than 0.01% by mass, the resin particles may aggregate with each other, especially when the pH of the resin particle dispersion liquid is not sufficiently basic. In the colorant dispersion liquid and the releasing agent dispersion liquid, the amount of the surfactant(s) is 0.01% by mass to 10% by mass, preferably 0.1% by mass to 5% by mass, more preferably 0.5% by mass to 0.2% by mass. When it is less than 0.01% by mass, some specific particles may problematically be released upon aggregation since the particles are different in stability. Whereas when it is more than 10% by mass, the particle size distribution of the particles becomes broad, making it difficult to control the particle diameter of the particles.

In addition to the above resin, colorant and releasing agent, the electrostatic image developing toner of the present invention may contain fine particles of other ingredients such as an internal additive, a charge controlling agent, inorganic powder, organic powder, a lubricant and a polishing agent.

The internal additive is used so as not to impede chargeability of the formed toner. Examples thereof include magnetic materials including metals such as ferrite, magnetite, reduced iron, cobalt and manganese, alloys thereof, and compounds containing these metals.

The charge controlling agent is not particularly limited. Especially for color toners, colorless or light-colored ones are preferably used. Examples thereof include quaternary ammonium salts, nigrosine dyes, dyes formed of complexes containing aluminum, iron and chromium, and triphenylmethane pigments.

Examples of the inorganic powder include any particles generally used as the external additive on the toner surface, such as silica, titania, calcium carbonate, magnesium carbonate, tricalcium phosphate and cerium oxide.

Examples of the organic powder include any particles generally used as the external additive on the toner surface, such as vinyl resins, polyester resins and silicone resins.

Notably, these inorganic powder and organic powder can be used as a flowability aid and a cleaning aid, for example.

Examples of the lubricant include fatty acid amides such as ethylenebisstearic acid amide and oleic acid amide and fatty acid metal salts such as zinc stearate and calcium stearate.

Examples of the polishing agent include the aforementioned silica, alumina and cerium oxide.

When mixing together the resin particle dispersion liquid, dispersion liquid of an inorganic layered mineral at least partially modified with an organic ion, colorant dispersion liquid and releasing agent dispersion liquid, the amount of the colorant may be 50% by mass or less, preferably 2% by mass to 40% by mass. The amount of the inorganic layered mineral at least partially modified with an organic ion is preferably 0.05% by mass to 10% by mass. Also, the amount of the other ingredients may be such an amount as not to impede the effects of the present invention. In general, the amount thereof is extremely small. Specifically, it is 0.01% by mass to 5% by mass, preferably 0.5% by mass to 2% by mass.

In the present invention, for example, an aqueous medium is used as a dispersion medium of the resin particle dispersion liquid, a dispersion medium of the dispersion liquid of an inorganic layered mineral at least partially modified with an organic ion, a dispersion medium of the colorant dispersion liquid, a dispersion medium of the releasing agent dispersion liquid or a dispersion medium of the dispersion liquids of the other ingredients. Specific examples of the aqueous medium include water such as distilled water and ion-exchange water and alcohols. These may be used alone or in combination.

At the step of preparing a dispersion liquid of aggregated particles in the present invention, the emulsifying agent is adjusted in emulsifying power through adjustment of pH, thereby causing aggregation to prepare aggregated particles.

An aggregating agent may be used for performing particle aggregation stably and rapidly as well as producing aggregated particles with a narrower particle size distribution.

The aggregating agent is preferably a compound having one or more charges. Specific examples thereof include water-soluble surfactants such as the above ionic surfactants and nonionic surfactants; acids such as hydrochloric acid, sulfuric acid, nitric acid, acetic acid and oxalic acid; metal salts of inorganic acids such as magnesium chloride, sodium chloride, aluminum sulfate, calcium sulfate, ammonium sulfate, ammonium nitrate, silver nitrate, copper nitrate and sodium carbonate; metal salts of aliphatic or aromatic acids such as sodium acetate, potassium formate, sodium oxalate, sodium phthalate and potassium salicylate; metal salts of phenols such as sodium phenolate; metal salts of amino acids; and inorganic acid salts of aliphatic or aromatic amines such as triethanolamine hydrochloride and aniline hydrochloride. Of these, metal salts of inorganic acids are preferred considering stability of the aggregated particles, stability over time of the aggregating agent to heat, and easiness of removal by washing.

The amount of the aggregating agent used depends on the number of charges it has. The amount of the aggregating agent is generally small. In the case of the aggregating agent having one charge, the amount thereof is about 3% by mass or less. In the case of the aggregating agent having two charges, the amount thereof is about 1% by mass or less. In the case of the aggregating agent having three charges, the amount thereof is about 0.5% by mass or less. The amount of the aggregating agent is preferably less. Thus, the compound having more charges are preferably used since the amount thereof can be smaller.

### <<Toner Production Method by Pulverization Method>>

The kneading and pulverizing method is a method for producing base particles of the above toner through a process including: melt-kneading a toner material containing at least a binder resin and a releasing agent; pulverizing the obtained kneaded product; classifying the pulverized product.

In this melt-kneading, the toner material is mixed and then the resultant mixture is melt-kneaded with a melt kneader. Examples of the melt kneader include uniaxial or biaxial continuous kneaders and batch kneaders using a roll mill. Preferred examples thereof include a KTK-type biaxial extruder (product of KOBE STEEL. Ltd.), a TEM-type extruder (product of TOSHIBA MACHINE CO., LTD.), a biaxial extruder (product of KCK Co., Ltd.), a PCM-type biaxial extruder (product of IKEGAI LTD.) and a co-kneader (product of BUSS Company). Preferably, the melt-kneading is performed under appropriate conditions so as not to cleave the molecular chains of the binder resin. The temperature during melt-kneading is determined in consideration of the softening point of the binder resin. Specifically, when the temperature is much higher than the softening point, cleavage of the molecular chains occurs to a considerable extent; whereas when the temperature is much lower than the softening point, a sufficient dispersion state is difficult to attain.

The thus-kneaded product is pulverized to form particles. In this pulverization, the kneaded product is roughly pulverized and then finely pulverized. Preferred examples of pulverizing methods include a method in which the kneaded product is crushed against a collision plate under a jet stream for pulverization, a method in which the kneaded particles are crushed one another under a jet stream for pulverization, and a method in which the kneaded product is pulverized by passage through the narrow gap between a mechanically rotating rotor and a stator.

The thus-pulverized product is classified to prepare particles having a predetermined particle diameter. This classification is performed by removing microparticles with a cyclone, a decanter, a centrifugal separator, etc.

After completion of the above pulverization and classification, the obtained pulverized product is classified in a gas flow by the action of centrifugal force, whereby toner base particles having a predetermined particle diameter can be produced.

Subsequently, an external additive is added to the toner base particles. Specifically, the toner particles and the external additive are mixed with each other under stirring using a mixer, whereby the toner particles are covered with pulverized products of the external additive. In this treatment, in terms of durability of the formed toner, it is important that an external additive (e.g., inorganic microparticles or resin microparticles) is made to adhere to toner base particles uniformly and firmly.

### (Developer)

A developer of the present invention contains at least the electrostatic image developing toner of the present invention, and is preferably a two-component developer further containing a carrier. In the two-component developer, the amount of the toner is preferably 1% by mass to 10% by mass relative to the amount of the carrier.

The carrier may be, for example, iron powder, ferrite powder or magnetite powder having an average particle diameter of about 20 μm to about 200 μm.

The carrier may be coated with a coating resin. Examples of the coating resin include amino-based resins such as urea-formaldehyde resins, melamine resins, benzoguanamine resins, urea resins and polyamide resins; epoxy resins; polyvinyl-based resins such as acryl resins, polymethyl methacrylates, polyacrylonitriles, polyvinyl acetates, polyvinyl alcohols and polyvinyl butyrals; polyvinylidene-based resins; polystyrene-based resins such as polystyrenes and styrene-acryl copolymer resins; halogenated olefin resins such as polyvinyl chlorides; polyester-based resins such as polyethylene terephthalates and polybutyrene terephthalates; polycarbonate-based resins, polyethylenes, polyvinyl fluorides, polyvinylidene fluorides, polytrifluoroethylenes, polyhexafluoropropylenes, copolymers of vinylidene fluoride and an acryl monomer, copolymers of vinylidene fluoride and vinyl fluoride, fluoroterpolymers of tetrafluoroethylene, vinylidene fluoride and a non-fluorinated monomer; and silicone resins.

Also, examples of the coating material include amino-based resins such as urea-formaldehyde resins, melamine resins, benzoguanamine resins, urea resins and polyamide resins.

Further examples include polyvinyl- or polyvinylidene-based resins such as acryl resins, polymethyl methacrylate resins, polyacrylonitrile resins, polyvinyl acetate resins, polyvinyl alcohol resins and polyvinyl butyral resins; polystyrene-based resins such as polystyrene resins and styrene-acryl copolymer resins; halogenated olefin resins such as polyvinyl chlorides; polyester-based resins such as polyethylene terephthalate resins and polybutyrene terephthalate resins; polycarbonate-based resins, polyethylene resins, polyvinyl fluoride resins, polyvinylidene fluoride resins, polytrifluoroethylene resins, polyhexafluoropropylene resins, copolymers of vinylidene fluoride and an acryl monomer, copolymers of vinylidene fluoride and vinyl fluoride, fluoroterpolymers of tetrafluoroethylene, vinylidene fluoride and a non-fluorinated monomer; silicone resins; and epoxy resins.

If necessary, the coating resin may contain, for example, conductive powder such as metal powder, carbon black, titanium oxide, tin oxide and zinc oxide.

The average particle diameter of the conductive powder is preferably 1 μm or smaller. When the average particle diameter of the conductive powder is greater than 1 μm, the electrical resistance of the formed resin layer may be difficult to control.

Alternatively, the developer of the present invention may be a one-component developer containing no carrier; i.e., a magnetic toner or non-magnetic toner.

### EXAMPLES

The present invention will next be described in more detail by way of Examples, which should not be construed as limiting the present invention thereto. In the following Examples, the unit “part(s)” means “part(s) by mass.”

### —Synthesis of Crystalline Polyester Resin 1—

A 5 L four-neck flask equipped with a nitrogen-introducing pipe, a drainpipe, a stirrer and a thermocouple was charged with 1,10-decanedioic acid (2,120 g), 1,8-octanediol (1,000 g), 1,4-butandiol (1,520 g) and hydroquinone (3.9 g), followed by reaction at 180° C. for 10 hours. Thereafter, the reaction mixture was allowed to react at 200° C. for 3 hours and further react at 8.3 kPa for 2 hours, to thereby produce crystalline polyester resin 1. The thus-produced crystalline polyester resin 1 was found to have a melting point of 67° C. as measured by the above-described method.

### —Synthesis of Crystalline Polyester Resin 2—

A 5 L four-neck flask equipped with a nitrogen-introducing pipe, a drainpipe, a stirrer and a thermocouple was charged with 1,12-dodecanediol (2,500 g), 1,8-octanedioic acid (2,330 g) and hydroquinone (2.9 g), followed by reaction at 180° C. for 30 hours. Thereafter, the reaction mixture was allowed to react at 200° C. for 10 hours and further react at 8.3 kPa for 15 hours, to thereby produce crystalline polyester resin 2. The thus-produced crystalline polyester resin 2 was found to have a melting point of 72° C. as measured by the above-described method.

### —Synthesis of Crystalline Polyester Resin 3—

A 5 L four-neck flask equipped with a nitrogen-introducing pipe, a drainpipe, a stirrer and a thermocouple was charged with fumaric acid (1,160 g) 1,10-decanedioic acid (1,520 g), 1,6-octanediol (1,020 g), 1,4-butanediol (1,300 g) and hydroquinone (4.9 g), followed by reaction at 180° C. for 10 hours. Thereafter, the reaction mixture was allowed to react at 200° C. for 3 hours and further react at 8.3 kPa for 2 hours, to thereby produce crystalline polyester resin 3. The thus-produced crystalline polyester resin 3 was found to have a melting point of 82° C. as measured by the above-described method.

### —Synthesis of Crystalline Polyester Resin 4—

The procedure of the synthesis of crystalline polyester resin 1 was repeated, except that the reaction time at 180° C. was changed to 2 hours, to thereby produce crystalline polyester resin 4. The thus-produced crystalline polyester resin 4 was found to have a melting point of 58° C. as measured by the above-described method.

### —Synthesis of Non-Crystalline Polyester Resin 1—

A 5 L four-neck flask equipped with a nitrogen-introducing pipe, a drainpipe, a stirrer and a thermocouple was charged with bisphenol A ethylene oxide 2 mole adduct (229 parts), bisphenol A propylene oxide 3 mole adduct (529 parts), isophthalic acid (100 parts), terephthalic acid (108 parts), adipic acid (46 parts) and dibutyltin oxide (2 parts). The reaction mixture was allowed to react under normal pressure at 230° C. for 10 hours and further react under a reduced pressure of 10 mmHg to 15 mmHg for 5 hours. Then, trimellitic anhydride (30 parts) was added to the reaction container, followed by reaction at 180° C. under normal pressure for 3 hours, to thereby produce [non-crystalline polyester 1]. The [non-crystalline polyester 1] was found to have a number average molecular weight of 1,800, a weight average molecular weight of 5,500, a Tg of 42° C. and an acid value of 20.

### —Synthesis of Non-Crystalline Polyester Resin 2—

A 5 L four-neck flask equipped with a nitrogen-introducing pipe, a drainpipe, a stirrer and a thermocouple was charged with bisphenol A ethylene oxide 2 mole adduct (229 parts), bisphenol A propylene oxide 3 mole adduct (529 parts), isophthalic acid (70 parts), terephthalic acid (98 parts), fumaric acid (46 parts) and dodecenylsuccinic acid (24 parts), each serving a starting material, as well as dibutyltin oxide (2 parts). Nitrogen gas was introduced into the flask to keep the flask in an inert atmosphere. The resultant mixture was increased in temperature and was allowed to undergo co-condensation polymerization reaction at 230° C. for 12 hours. Thereafter, the flask was gradually reduced in pressure at 230° C. to thereby synthesize [non-crystalline polyester resin 2]. The [non-crystalline polyester 2] was found to have a number average molecular weight of 6,700, a weight average molecular weight of 17,400, a Tg of 70° C. and an acid value of 14.

### —Synthesis of Polyester Prepolymer—

A reaction container equipped with a condenser, a stirrer and a nitrogen-introducing pipe was charged with bisphenol A ethylene oxide 2 mole adduct (682 parts), bisphenol A propylene oxide 2 mole adduct (81 parts), terephthalic acid (283 parts), trimellitic anhydride (22 parts) and dibutyltin oxide (2 parts). The resultant mixture was allowed to react under normal pressure at 230° C. for 8 hours and further react at a reduced pressure of 10 mmHg to 15 mmHg for 5 hours, to thereby produce [intermediate polyester 1]. The [intermediate polyester 1] was found to have a number average molecular weight of 2,100, a weight average molecular weight of 9,500, a Tg of 55° C., an acid value of 0.5 and a hydroxyl value of 51.

Next, a reaction container equipped with a condenser, a stirrer and a nitrogen-introducing pipe was charged with 410 parts of [intermediate polyester 1], 89 parts of isophorone diisocyanate and 500 parts of ethyl acetate, followed by reaction at 100° C. for 5 hours, to thereby produce [prepolymer 1]. The amount of free isocyanate contained in [prepolymer 1] was found to be 1.53% by mass.

Notably, the amount of the free isocyanate group (% by mass) was measured as follows. Specifically, about 2 g of the [prepolymer 1] (sample) was accurately weighed, and 5 mL of dry toluene was immediately mixed therewith to completely dissolve the sample. Subsequently, 5 mL of 0.1 M n-dibutylamine/toluene solution was added to the resultant solution with a pipette, followed by gently stirring for 15 min. In addition, 5 mL of isopropanol was added thereto, followed by stirring. The resultant mixture was subjected to potentiometric titration using 0.1M ethanol standard liquid of hydrochloric acid. The obtained titration value was used to calculate the amount of dibutylamine consumed, which was then used to calculate the amount of the free isocyanate group.

### —Synthesis of Ketimine—

A reaction container equipped with a stirring rod and a thermometer was charged with isophorone diamine (170 parts) and methyl ethyl ketone (75 parts), followed by reaction at 50° C. for 5 hours, to thereby produce [ketimine compound 1]. The amine value of [ketimine compound 1] was found to be 418.

### —Preparation of Masterbatch (MB)—

Water (1,200 parts), carbon black (Printex35, product of Degussa) [DBP oil absorption amount=42 mL/100 mg, pH=9.5] (540 parts) and a polyester resin (1,200 parts) were mixed together with HENSCHEL MIXER (product of Mitsui Mining Co., Ltd). The resultant mixture was kneaded at 150° C. for 30 min with a two-roller mill, and then rolled, cooled and pulverized with a pulverizer, to thereby produce [masterbatch 1].

### —Preparation of Oil Phase—

A container equipped with a stirring rod and a thermometer was charged with [non-crystalline polyester 1] (378 parts), a microcrystalline wax (HI-MIC-1090; melting point: 72° C., product of NIPPON SEIRO CO., LTD.) (110 parts), CCA (salycilic acid metal complex E-84: product of Orient Chemical Industries, Ltd.) (22 parts) and ethyl acetate (947 parts), and the mixture was heated to 80° C. under stirring. The resultant mixture was maintained at 80° C. for 5 hours and then cooled to 30° C. over 1 hour. Subsequently, [masterbatch 1] (500 parts) and ethyl acetate (500 parts) were charged into the container, followed by mixing for 1 hour, to thereby prepare [raw material solution 1].

[Raw material solution 1] (1,324 parts) was placed in a container, and the carbon black and WAX were dispersed with a beads mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed in 80% by volume, and 3 passes. Next, a 65% by mass ethyl acetate solution of [non-crystalline polyester 1] (1,042.3 parts) was added thereto, and passed once with the beads mill under the above conditions, to thereby obtain [pigment/WAX dispersion liquid 1]. The solid content of [pigment/WAX dispersion liquid 1] was found to be 50% by mass (130° C., 30 min).

### —Preparation of Crystalline Polyester Dispersion Liquid 1—

A 20 L metal container was charged with [crystalline polyester resin 1] (1,600 g) and ethyl acetate (11,200 g). The mixture was heated at 75° C. for dissolution and then quenched in an ice-water bath at a rate of 27° C./min. Thereafter, [non-crystalline polyester resin 1] (3,200 g) was added to the mixture, which was stirred for 5 hours to dissolve [non-crystalline polyester resin 1]. The resultant mixture was dispersed with a beads mill (LMZ2; product of Ashizawa Finetech Ltd.) under the following conditions: 0.3-mm zirconia beads packed: 85% by volume, 20 passes, and temperature of seal liquid for beads mill shaft: 15° C., to thereby obtain [crystalline polyester dispersion liquid 1].

### —Preparation of Crystalline Polyester Dispersion Liquid 2—

The procedure for preparing “crystalline polyester dispersion liquid 1” was repeated, except that the temperature of seal liquid for beads mill shaft was changed to 20° C., to thereby obtain [crystalline polyester dispersion liquid 2].

### —Preparation of Crystalline Polyester Dispersion Liquid 3—

The procedure for preparing “crystalline polyester dispersion liquid 1” was repeated, except that [crystalline polyester resin 1] was changed to [crystalline polyester resin 2], which was heated at 80° C. for dissolution, to thereby obtain [crystalline polyester dispersion liquid 3].

### —Preparation of Crystalline Polyester Dispersion Liquid 4—

The procedure for preparing “crystalline polyester dispersion liquid 1” was repeated, except that [crystalline polyester resin 1] was changed to [crystalline polyester resin 4] and that the temperature of seal liquid for beads mill shaft was changed to 25° C., to thereby obtain [crystalline polyester dispersion liquid 4].

### —Preparation of Crystalline Polyester Dispersion Liquid 5—

The procedure for preparing “crystalline polyester dispersion liquid 1” was repeated, except that [non-crystalline polyester resin 1] was changed to [non-crystalline polyester resin 2], to thereby obtain [crystalline polyester dispersion liquid 5].

### —Preparation of Crystalline Polyester Dispersion Liquid 6—

A 20 L metal container was charged with [crystalline polyester resin 1] (1,600 g) and ethyl acetate (11,200 g). The mixture was heated at 75° C. for dissolution and then quenched in an ice-water bath at a rate of 27° C./min. Thereafter, [non-crystalline polyester resin 1] (3,200 g) was added to the mixture, which was stirred for 5 hours to dissolve [non-crystalline polyester resin 1]. The resultant mixture was dispersed with a beads mill (LMZ2; product of Ashizawa Finetech Ltd.) under the following conditions: 0.3-mm zirconia beads packed: 85% by volume, 20 passes, and temperature of seal liquid for beads mill shaft: 25° C., to thereby obtain [crystalline polyester dispersion liquid 6].

### —Preparation of Non-Crystalline Polyester Dispersion Liquid 1—

A 20 L metal container was charged with [non-crystalline polyester resin 1] (1,600 g) and ethyl acetate (11,200 g). The mixture was heated under stirring at 50° C. for dissolution, to thereby prepare [non-crystalline polyester resin dispersion liquid 1].

### —Preparation of Fine Organic Particle Emulsion—

A reaction container equipped with a stirring rod and a thermometer was charged with water (683 parts), a sodium salt of sulfuric acid ester of methacrylic acid-ethylene oxide adduct (ELEMINOL RS-30: product of Sanyo Chemical Industries, Ltd.) (11 parts), styrene (138 parts), methacrylic acid (138 parts) and ammonium persulfate (1 part), and the resultant mixture was stirred at 400 rpm for 15 min to prepare a white emulsion. The thus-obtained emulsion was heated to 75° C. and allowed to react for 5 hours. Subsequently, a 1% by mass aqueous ammonium persulfate solution (30 parts) was added to the reaction mixture, followed by aging at 75° C. for 5 hours, to thereby prepare an aqueous dispersion liquid [fine particle dispersion liquid 1] of a vinyl resin (a copolymer of styrene-methacrylic acid-sodium salt of sulfuric acid ester of methacrylic acid ethylene oxide adduct). The thus-prepared [fine particle dispersion liquid 1] was measured for volume average particle diameter with LA-920 and was found to have a volume average particle diameter of 0.14 μm. Part of the [fine particle dispersion liquid 1] was dried to separate resin.

### —Preparation of Aqueous Phase—

Water (990 parts), [fine particle dispersion liquid 1] (83 parts), a 48.5% aqueous solution of sodium dodecyldiphenyl ether disulfonate (ELEMINOL MON-7, product of Sanyo Chemical Industries Ltd.) (37 parts) and ethyl acetate (90 parts) were mixed together and stirred to obtain an opaque white liquid, which was used as [aqueous phase 1].

### —Emulsification/Desolvation—

[Pigment/WAX dispersion liquid 1] (664 parts), [prepolymer 1] (109.4 parts), [crystalline polyester dispersion liquid 1] (73.9 parts) and [ketimine compound 1] (4.6 parts) were placed in a container, followed by mixing for 1 min at 5,000 rpm with a TK homomixer (product of Tokushu Kika Kogyo Co., Ltd.). Thereafter, [aqueous phase 1] (1,200 parts) was added to the container, and the resultant mixture was mixed with the TK homomixer at 13,000 rpm for 20 min, to thereby obtain [emulsified slurry 1].

A container equipped with a stirrer and a thermometer was charged with [emulsified slurry 1], followed by desolvation at 30° C. for 8 hours and aging at 45° C. for 4 hours, to thereby produce [dispersion slurry 1].

### —Washing/Drying—

[Dispersion slurry 1] (100 parts) was filtrated under reduced pressure and then subjected to a series of treatments (1) to (4) described below, to thereby obtain [filtration cake 1]:

(1): ion-exchanged water (100 parts) was added to the filtration cake, followed by mixing with a TK homomixer (at 12,000 rpm for 10 min) and then filtration;

(2): 10% aqueous sodium hydroxide solution (100 parts) was added to the filtration cake obtained in (1), followed by mixing with a TK homomixer (at 12,000 rpm for 30 min) and then filtration under reduced pressure;

(3): 10% by mass hydrochloric acid (100 parts) was added to the filtration cake obtained in (2), followed by mixing with a TK homomixer (at 12,000 rpm for 10 min) and then filtration; and

(4): ion-exchanged water (300 parts) was added to the filtration cake obtained in (3), followed by mixing with a TK homomixer (at 12,000 rpm for 10 min) and then filtration (this treatment (4) was performed twice).

[Filtration cake 1] was dried with an air-circulating drier at 45° C. for 48 hours, and then was caused to pass through a sieve with a mesh size of 75 μm, to thereby prepare [base toner 1].

—Mixing with External Additive—

Using HENSCHEL MIXER, [base toner 1] (100 parts) was stirred and mixed with 1.0 part of hydrophobic silica (HDK-2000, product of Clariant Co.) serving as an external additive, to thereby obtain [toner (toner particles) 1] having a Tg of 45° C. and an adhesive force between the toner particles of 2.0 mN measured after it had been stored at the high temperature.

Notably, the steps performed for obtaining [toner 1] are Example 1.

### Example 2

The procedure of Example 1 was repeated, except that [crystalline polyester dispersion liquid 1] was changed to [crystalline polyester dispersion liquid 2], to thereby obtain [toner 2]. [Toner 2] was found to have a Tg of 45° C. and an adhesive force between the toner particles of 1.4 mN measured after it had been stored at the high temperature.

Notably, the emulsified slurry, the dispersion slurry and the base toner obtained in Example 2 are referred to as [emulsified slurry 2], [dispersion slurry 2] and [base toner 2], respectively.

### Example 3

The procedure of Example 1 was repeated, except that [crystalline polyester dispersion liquid 1] was changed to [crystalline polyester dispersion liquid 3], to thereby obtain [toner 3]. [Toner 3] was found to have a Tg of 50° C. and an adhesive force between the toner particles of 2.0 mN measured after it had been stored at the high temperature.

Notably, the emulsified slurry, the dispersion slurry and the base toner obtained in Example 3 are referred to as [emulsified slurry 3], [dispersion slurry 3] and [base toner 3], respectively.

### Example 4

The procedure of Example 1 was repeated, except that [crystalline polyester dispersion liquid 1] was changed to [crystalline polyester dispersion liquid 5], to thereby obtain [toner 4]. [Toner 4] was found to have a Tg of 60° C. and an adhesive force between the toner particles of 1.4 mN measured after it had been stored at the high temperature.

Notably, the emulsified slurry, the dispersion slurry and the base toner obtained in Example 4 are referred to as [emulsified slurry 4], [dispersion slurry 4] and [base toner 4], respectively.

### Example 5

The procedure of Example 1 was repeated, except that in the Emulsification/Desolvation, the amount of [crystalline polyester dispersion liquid 1] was changed from 73.9 parts to 88.2 parts, to thereby obtain [toner 5]. [Toner 5] was found to have a Tg of 55° C. and an adhesive force between the toner particles of 1.7 mN measured after it had been stored at the high temperature.

Notably, the emulsified slurry, the dispersion slurry and the base toner obtained in Example 5 are referred to as [emulsified slurry 5], [dispersion slurry 5] and [base toner 5], respectively.

### Example 6

The procedure of Example 1 was repeated, except that in the Emulsification/Desolvation, the amount of [crystalline polyester dispersion liquid 1] was changed from 73.9 parts to 59.6 parts, to thereby obtain [toner 6]. [Toner 6] was found to have a Tg of 54° C. and an adhesive force between the toner particles of 2.0 mN measured after it had been stored at the high temperature.

Notably, the emulsified slurry, the dispersion slurry and the base toner obtained in Example 6 are referred to as [emulsified slurry 6], [dispersion slurry 6] and [base toner 6], respectively.

### Example 7

A production method and a composition of materials in Example 7 are given below.

### (Composition of Materials)

| | | |
|---|---|---|
| Binder resin: Crystalline polyester 1 | 8 | parts |
| Binder resin: Non-crystalline polyester 2 | 86 | parts |
| Colorant: Carbon black C-44 | 7 | parts |
| (product of Mitsubishi Chemical Corporation, average particle | | |
| diameter: 24 nm, BET specific surface area: 125 m²/g) | | |
| CCA: BONTRON E-84 (product of ORIENT CHEMICAL | 1 | part |
| INDUSTRIES CO., LTD.) | | |
| Microcrystalline wax: HI-MIC-1090 (product of NIPPON | 6 | parts |
| SEIRO CO., LTD., melting point: 72° C.) | | |

The toner powdery materials were thoroughly mixed together using a super mixer (SMV-200, product of KAWATA MFG CO., Ltd.) to thereby obtain a toner powdery material mixture. This toner powdery material mixture was fed to a material-feeding hopper of BUSS CO-KNEADER (TCS-100, product of BUSS Company) and then kneaded at a feed amount of 120 kg/h.

The kneaded product was calendered and cooled with a double belt cooler. The thus-treated product was coarsely pulverized with a hammer mill and then finely pulverized with a jet airflow-type mill (1-20 jet mill, product of Nippon Pneumatic Co.). The obtained pulverized product was classified with a wind-driven classifier (DS-20-DS-10 classifier, product of Nippon Pneumatic Co.) to thereby obtain [base toner 7]. Using HENSCHEL MIXER, [base toner 7] (100 parts) was stirred and mixed with 1.0 part of hydrophobic silica (HDK-2000, Clariant Co.) serving as an external additive, to thereby obtain [toner 7] having a Tg of 58° C. In [toner 7], the adhesive force between the toner particles after storage at a high temperature was found to be 1.6 mN.

### Example 8

The procedure of Example 7 was repeated, except that the amount of [crystalline polyester 1] was changed from 8 parts to 10 parts, to thereby obtain [toner 8]. [Toner 8] was found to have a Tg of 55° C. and an adhesive force between the toner particles of 1.4 mN measured after it had been stored at the high temperature.

Notably, the base toner obtained in Example 8 is referred to as [base toner 8].

### Example 9

The procedure of Example 7 was repeated, except that the amount of [crystalline polyester 1] was changed from 8 parts to 6 parts, to thereby obtain [toner 9]. [Toner 9] was found to have a Tg of 55° C. and an adhesive force between the toner particles of 1.8 mN measured after it had been stored at the high temperature.

Notably, the base toner obtained in Example 9 is referred to as [base toner 9].

### Example 10

### Preparation of Pigment Dispersion Liquid

A container was charged with 20 parts of carbon black (MA100S, product of Mitsubishi Chemical Corporation), 80 parts of ion-exchange water and 4.0 parts of an anionic surfactant (NEOGEN R-K, product of DAI-ICHI KOGYO SEIYAKU CO., LTD.). The resultant mixture was treated with a beads mill (ULTRA VISCO MILL, product of Aymex Co.) under the following conditions: liquid-feeding rate; 1 kg/h; disc circumferential speed: 6 m/sec; 0.3-mm zirconia beads packed: 80% by volume; pass time: 15, to thereby prepare a pigment dispersion liquid 1 containing pigment particles having a volume average particle diameter of 0.07 μm (solid content concentration: 19.8% by mass).

### (Preparation of Wax Dispersion Liquid)

A microcrystalline wax (HI-MIC-1090, melting point: 72° C., product of NIPPON SEIRO CO., LTD.) (20 parts), 80 parts of ion-exchange water and 4 parts of an anionic surfactant (NEOGEN R-K, product of DAI-ICHI KOGYO SEIYAKU CO., LTD.) were mixed together. While being stirred, the resultant mixture was increased in temperature to 95° C. and maintained for 1 hour, followed by cooling. Next, the obtained mixture was treated with a beads mill (ULTRA VISCO MILL, product of Aymex Co.) under the following conditions: liquid-feeding rate: 1 kg/h; disc circumferential speed: 6 m/sec; the amount of zirconia beads having a particle diameter of 0.3 mm packed: 80% by volume; pass time: 25, to thereby prepare a wax dispersion liquid 1 containing wax particles having a volume average particle diameter of 0.15 μm (solid content concentration: 20.8% by mass).

### (Preparation of CCA Dispersion Liquid)

A container was charged with 5 parts of CCA (BONTRON E-84, product of Orient Chemical Industries, Ltd.), 95 parts of ion-exchange water and 0.5 parts of an anionic surfactant (NEOGEN R-K, product of DAI-ICHI KOGYO SEIYAKU CO., LTD.). The resultant mixture was treated with a beads mill (ULTRA VISCO MILL, product of Aymex Co.) under the following conditions: liquid-feeding rate: 1 kg/h; disc circumferential speed: 6 m/sec; the amount of zirconia beads having a particle diameter of 0.3 mm packed: 80% by volume; pass time: 5, to thereby prepare a CCA dispersion liquid 1 (solid content concentration: 4.8% by mass).

### (Toner Preparation Method)

The following dispersion liquids were stirred with a disperser at a constant temperature of 25° C. for 2 hours.

| | |
|---|---|
| Pigment dispersion liquid 1 | 35.4 parts |
| CCA dispersion liquid 1 | 20.8 parts |
| Crystalline polyester dispersion liquid 1 | 67.2 parts |
| Non-crystalline polyester dispersion liquid 1 | 634.1 parts |
| Wax dispersion liquid 1 | 28.8 parts |

Next, the resultant dispersion liquid was heated to 60° C. and adjusted with ammonia so as to have a pH of 7.0. Furthermore, the dispersion liquid was heated to 90° C. and maintained for 6 hours at the same temperature, to thereby obtain dispersion slurry 1.

The obtained dispersion slurry 1 (100 parts) was filtrated under reduced pressure and then subjected to a series of treatments (1) to (3) described below, to thereby obtain [filtration cake 1]:

(1): ion-exchange water (100 parts) was added to the filtration cake, followed by mixing with a TK homomixer (at 12,000 rpm for 10 min) and then filtration;

(2): 10% hydrochloric acid was added to the filtration cake obtained in (1) so as to have a pH of 2.8, followed by mixing with a TK homomixer (at 12,000 rpm for 10 min) and then filtration; and

(3): ion-exchange water (300 parts) was added to the filtration cake obtained in (2), followed by mixing with a TK homomixer (at 12,000 rpm for 10 min) and then filtration (this treatment (3) was performed twice).

[Filtration cake 1] was dried with an air-circulating drier at 45° C. for 48 hours, and then was caused to pass through a mesh with an aperture of 75 μm, to thereby prepare [base toner 10].

—Mixing with External Additive—

Using HENSCHEL MIXER, [base toner 10] (100 parts) was stirred and mixed with 1.0 part of hydrophobic silica (HDK-2000, product of Clariant Co.) serving as an external additive, to thereby obtain [toner 10] having a Tg of 56° C. and an adhesive force between the toner particles of 1.5 mN measured after it had been stored at the high temperature.

### Example 11

The procedure of Example 6 was repeated, except that [crystalline polyester dispersion liquid 1] was changed to [crystalline polyester dispersion liquid 5], to thereby obtain [toner 11]. [Toner 11] was found to have a Tg of 59° C. and an adhesive force between the toner particles of 2.2 mN measured after it had been stored at the high temperature.

Notably, the emulsified slurry, the dispersion slurry and the base toner obtained in Example 11 are referred to as [emulsified slurry 11], [dispersion slurry 11] and [base toner 11], respectively.

### Example 12

[Base toner 2] obtained in Example 2 was heated with an air-circulating drier at 50° C. for 12 hours, to thereby obtain [base toner 12]. [Base toner 12] was mixed with the external additive in the same manner as in Example 1, to thereby obtain [toner 12] having a Tg of 45° C. and an adhesive force between the toner particles of 1.6 mN measured after it had been stored at the high temperature.

Notably, the emulsified slurry and the dispersion slurry obtained in Example 12 are referred to as [emulsified slurry 12] and [dispersion slurry 12], respectively.

### Example 13

The procedure of Example 2 was repeated, except that [emulsified slurry 2] obtained in Example 2 was desolvated and then aged at 50° C. for 8 hours to prepare [dispersion slurry 13], to thereby obtain [toner 13]. [Toner 13] was found to have a Tg of 60° C. and an adhesive force between the toner particles of 1.6 mN measured after it had been stored at the high temperature.

Notably, the emulsified slurry and the base toner obtained in Example 13 are referred to as [emulsified slurry 13] and [base toner 13], respectively.

### Example 14

[Base toner 13] obtained in Example 13 was heated with an air-circulating drier at 50° C. for 12 hours, to thereby obtain [base toner 14]. [Base toner 14] was mixed with an external additive in the same manner as in Example 1, to thereby obtain [toner 14] having a Tg of 60° C. and an adhesive force between the toner particles of 1.8 mN measured after it had been stored at the high temperature.

Notably, the emulsified slurry and the dispersion slurry obtained in Example 14 are referred to as [emulsified slurry 14] and [dispersion slurry 14], respectively.

### Comparative Example 1

The procedure of Example 1 was repeated, except that [crystalline polyester dispersion liquid 1] was not used, to thereby obtain [toner 15]. [Toner 15] was found to have a Tg of 57° C. and an adhesive force between the toner particles of 2.1 mN measured after it had been stored at the high temperature.

Notably, the emulsified slurry, the dispersion slurry and the base toner obtained in Comparative Example 1 are referred to as [emulsified slurry 15], [dispersion slurry 15] and [base toner 15], respectively.

### Comparative Example 2

The procedure of Example 1 was repeated, except that [crystalline polyester dispersion liquid 1] was changed to [crystalline polyester dispersion liquid 6], to thereby obtain [toner 16]. [Toner 16] was found to have a Tg of 40° C. and an adhesive force between the toner particles of 1.3 mN measured after it had been stored at the high temperature.

Notably, the emulsified slurry, the dispersion slurry and the base toner obtained in Comparative Example 2 are referred to as [emulsified slurry 16], [dispersion slurry 16] and [base toner 16], respectively.

### Comparative Example 3

The procedure of Example 1 was repeated, except that [crystalline polyester dispersion liquid 1] was not used and that [non-crystalline polyester resin 1] was changed to [non-crystalline polyester resin 2], to thereby obtain [toner 17]. [Toner 17] was found to have a Tg of 70° C. and an adhesive force between the toner particles of 2.3 mN measured after it had been stored at the high temperature.

Notably, the emulsified slurry, the dispersion slurry and the base toner obtained in Comparative Example 3 are referred to as [emulsified slurry 17], [dispersion slurry 17] and [base toner 17], respectively.

### Comparative Example 4

The procedure of Example 1 was repeated, except that [crystalline polyester dispersion liquid 1] was changed to [crystalline polyester dispersion liquid 4], to thereby obtain [toner 18]. [Toner 18] was found to have a Tg of 42° C. and an adhesive force between the toner particles of 1.2 mN measured after it had been stored at the high temperature.

Notably, the emulsified slurry, the dispersion slurry and the base toner obtained in Comparative Example 4 are referred to as [emulsified slurry 18], [dispersion slurry 18] and [base toner 18], respectively.

### Comparative Example 5

The procedure of Example 1 was repeated, except that [crystalline polyester dispersion liquid 1] was changed to [crystalline polyester dispersion liquid 5] and that in the Emulsification/Desolvation, the amount of [crystalline polyester dispersion liquid] was changed from 73.9 parts to 59.6 parts, to thereby obtain [toner 19]. [Toner 19] was found to have a Tg of 63° C. and an adhesive force between the toner particles of 2.0 mN measured after it had been stored at the high temperature.

Notably, the emulsified slurry, the dispersion slurry and the base toner obtained in Comparative Example 5 are referred to as [emulsified slurry 19], [dispersion slurry 19] and [base toner 19], respectively.

### Comparative Example 6

The procedure of Example 1 was repeated, except that [base toner 18] obtained in Comparative Example 4 was heated with an air-circulating drier at 50° C. for 12 hours, to thereby obtain [base toner 20]. [Base toner 20] was mixed with an external additive in the same manner as in Example 1, to thereby obtain [toner 20] having a Tg of 42° C. and an adhesive force between the toner particles of 1.3 mN measured after it had been stored at the high temperature.

Notably, the emulsified slurry, the dispersion slurry and the base toner obtained in Comparative Example 6 are referred to as [emulsified slurry 20], [dispersion slurry 20] and [base toner 20], respectively.

### (Preparation of Carrier)

Silicone resin (organo straight silicone) (100 parts), γ-(2-aminoethyl)aminopropyl trimethoxysilane (5 parts) and carbon black (10 parts) were added to toluene (100 parts). The resultant mixture was dispersed for 20 min with a Homomixer to prepare a coating layer forming liquid.

The coating layer forming liquid was coated on the surface of spherical magnetite particles having an average particle diameter of 50 μm (1,000 parts by mass) using a fluid bed coating apparatus, to thereby prepare a carrier.

### (Preparation of Developer)

Each (5 parts) of the toners was mixed with the carrier (95 parts) using a ball mill, to thereby prepare a developer.

### (Evaluation Methods and Results)

The prepared developer was evaluated for the following properties. The evaluation results are shown in Table 1.

### (Fixability)

A fixing portion of the copier MF-2200 (product of Ricoh Company, Ltd.) employing a TEFLON (registered trade mark) roller as a fixing roller was modified to produce a modified copier. This modified copier was used to perform a printing test using Type 6200 paper sheets (product of Ricoh Company, Ltd.).

Specifically, printing was performed with changing the fixing temperature, to thereby visually determine a cold offset temperature (minimum fixing temperature) and a hot offset temperature (maximum fixing temperature). Here, the minimum fixing temperature is defined as a minimum temperature at which the unfixed image transferred onto the fixing roller is not transferred again to the image receiving paper, and the maximum fixing temperature is defined as a maximum temperature at which the unfixed image transferred onto the fixing roller is not transferred again to the image receiving paper.

The evaluation conditions employed for determining the minimum fixing temperature were set as follows: paper-feeding linear velocity: 120 mm/s to 150 mm/s, surface pressure: 1.2 kgf/cm², and nip width: 3 mm.

The evaluation conditions employed for determining the maximum fixing temperature were set as follows: paper-feeding linear velocity: 50 mm/s, surface pressure: 2.0 kgf/cm², and nip width: 4.5 mm.

### (Heat Resistant Storage Stability)

After having been stored at 50° C. for 8 hours, the toner particles were sieved with a metal sieve having an aperture of 355 μm (42 mesh) for 2 min. Then, the toner remaining on the metal sieve (residual rate) was measured. Here, the less the residual rate of the toner is, the better the heat resistant storage stability of the toner is.

Notably, the following criteria were employed for the evaluation.

A: Residual rate<10%
B: 10%≦Residual rate<20%
C: 20%≦Residual rate<30%
D: 30%≦Residual rate

### [Image Evaluation]

A toner supply bottle was filled with the toner and stored at 30° C. and 60% RH for 4 weeks. Thereafter, the above-prepared developer and the toner supply bottle were used for continuous printing of a solid image on 100 sheets by means of IMAGIO NEO 450 (product of Ricoh Company Ltd.) which could output 45 A4-sheets per minute. The resulting images were evaluated for image quality based on the following criteria.

A: Uniform, good state
B: White lines having a width of less than 0.3 mm were slightly observed but were not clearly observed in the images.
C: White lines having a width of 0.3 mm or more occurred and were observed in less than 20 sheets out of 100 sheets of the solid image.
D: White lines having a width of 0.3 mm or more occurred and were observed in 20 sheets or more out of 100 sheets of the solid image.

The following Table 1 shows the evaluation results of Examples and Comparative Examples.

TABLE 1

| | | Adhesive force | Min. | Max. | Heat | |
|---|---|---|---|---|---|---|
| | | between particles | fixing | fixing | resistant | |
| | Tg | after storage at | temp. | temp. | storage | Image |
| | (° C.) | high temp. (mN) | (° C.) | (° C.) | stability | evaluation |
| Ex. 1 | 45 | 2.0 | 115 | 180 | B | A |
| Ex. 2 | 45 | 1.4 | 120 | 185 | B | B |
| Ex. 3 | 50 | 2.0 | 120 | 180 | A | A |
| Ex. 4 | 60 | 1.4 | 125 | 185 | A | B |
| Ex. 5 | 55 | 1.7 | 110 | 175 | B | B |
| Ex. 6 | 54 | 2.0 | 125 | 175 | A | A |
| Ex. 7 | 58 | 1.6 | 120 | 180 | A | A |
| Ex. 8 | 55 | 1.4 | 115 | 175 | B | B |
| Ex. 9 | 55 | 1.8 | 125 | 185 | B | A |
| Ex. 10 | 56 | 1.5 | 120 | 180 | A | A |
| Ex. 11 | 59 | 2.2 | 125 | 185 | A | A |
| Ex. 12 | 45 | 1.6 | 120 | 185 | B | A |
| Ex. 13 | 60 | 1.6 | 125 | 180 | A | B |
| Ex. 14 | 60 | 1.8 | 125 | 180 | A | A |
| Comp. | 57 | 2.1 | 135 | 185 | B | D |
| Ex. 1 | | | | | | |
| Comp. | 40 | 1.3 | 130 | 175 | D | D |
| Ex. 2 | | | | | | |
| Comp. | 70 | 2.3 | 140 | 180 | A | B |
| Ex. 3 | | | | | | |
| Comp. | 42 | 1.2 | 120 | 165 | D | D |
| Ex. 4 | | | | | | |
| Comp. | 63 | 2.0 | 130 | 180 | B | B |
| Ex. 5 | | | | | | |
| Comp. | 42 | 1.3 | 125 | 165 | D | D |
| Ex. 6 | | | | | | |

From the results of Examples 1 to 14 and Comparative Examples 1 to 6, even when used in a high-speed, full-color image forming apparatus, the electrostatic image developing toner of the present invention was found to be excellent in low-temperature fixability, developing stability, heat resistant storage stability and hot offset resistance.

1. Electrostatic image developing toner particles comprising:
a crystalline polyester resin;
a non-crystalline polyester resin;
a releasing agent; and
a colorant,
wherein the electrostatic image developing toner particles have a glass transition temperature of from 40° C. to 60° C. wherein the glass transition temperature is measured with a differential scanning calorimeter (DSC), and
the electrostatic image developing toner particles have an adhesive force between the toner particles of from 1.4 mN to 2.2 mN wherein the adhesive force between the toner particles is measured after the electrostatic image developing toner particles have been stored at 50° C.

2. The electrostatic image developing toner particles according to claim 1, wherein the adhesive force between the toner particles is from 1.4 mN to 2.0 mN.

3. The electrostatic image developing toner particles according to claim 1, wherein the crystalline polyester resin has a melting point of from 60° C. to 80° C.

4. The electrostatic image developing toner particles according to claim 1, wherein the electrostatic image developing toner particles are obtained by a method comprising:
dispersing, in an aqueous medium, an oil phase comprising the crystalline polyester resin and the non-crystalline polyester resin in an organic solvent, to obtain an O/W dispersion liquid; and
removing the organic solvent from the O/W dispersion liquid.

5. The electrostatic image developing toner particles according to claim 4, wherein the oil phase further comprises a binder resin precursor.

6. The electrostatic image developing toner particles according to claim 4, wherein
the oil phase comprises a binder resin precursor formed of a modified polyester resin,
the aqueous medium comprises a dispersing agent, and
the electrostatic image developing toner is obtained by a method comprising:
dissolving, in the oil phase, a compound capable of elongating or crosslinking with the binder resin precursor;
dispersing, in the aqueous medium, the oil phase in which the compound has been dissolved, to obtain a dispersion liquid;
allowing the binder resin precursor and the compound to undergo a crosslinking reaction, an elongating reaction, or both, in the dispersion liquid; and
removing the organic solvent from the dispersion liquid.

7. The electrostatic image developing toner particles according to claim 1, wherein the electrostatic image developing toner particles are obtained by a method comprising:
dispersing the crystalline polyester resin, and the non-crystalline polyester resin, respectively in separate aqueous media to emulsify the crystalline polyester resin and the non-crystalline polyester resin as crystalline polyester resin particles, and non-crystalline polyester resin particles, respectively;
mixing together the crystalline polyester resin particles, the non-crystalline polyester resin particles, a wax dispersion liquid in which the releasing agent is dispersed, and a colorant dispersion liquid in which the colorant is dispersed, to prepare an aggregated particle dispersion liquid in which aggregated particles are dispersed;
heating the aggregated particle dispersion liquid to a temperature that is equal to or higher than a melting point of the crystalline polyester resin particles and that is equal to or higher than a melting point of the non-crystalline polyester resin particles, to fuse and cohere the aggregated particles to form toner particles; and
washing the toner particles.

8. A developer comprising:
electrostatic image developing toner particles,
wherein the electrostatic image developing toner particles comprise:
a crystalline polyester resin;
a non-crystalline polyester resin;
a releasing agent; and
a colorant,
wherein the electrostatic image developing toner particles have a glass transition temperature of from 40° C. to 60° C. wherein the glass transition temperature is measured with a differential scanning calorimeter (DSC), and
the electrostatic image developing toner particles have an adhesive force between the toner particles of from 1.4 mN to 2.2 mN wherein the adhesive force between the toner articles is measured after the electrostatic image developing toner articles have been stored at 50° C.

9. The electrostatic image developing toner particles according to claim 2, wherein the crystalline polyester resin has a melting point of from 60° C. to 80° C.

10. The electrostatic image developing toner particles according to claim 2, wherein the electrostatic image developing toner particles are obtained by a method comprising:
dispersing, in an aqueous medium, an oil phase comprising the crystalline polyester resin and the non-crystalline polyester resin in an organic solvent, to obtain an O/W dispersion liquid; and
removing the organic solvent from the O/W dispersion liquid.

11. The electrostatic image developing toner particles according to claim 3, wherein the electrostatic image developing toner particles are obtained by a method comprising:
dispersing, in an aqueous medium, an oil phase comprising the crystalline polyester resin and the non-crystalline polyester resin in an organic solvent, to obtain an O/W dispersion liquid; and
removing the organic solvent from the O/W dispersion liquid.

12. The electrostatic image developing toner particles according to claim 10, wherein the oil phase further comprises a binder resin precursor.

13. The electrostatic image developing toner particles according to claim 11, wherein the oil phase further comprises a binder resin precursor.

14. The electrostatic image developing toner particles according to claim 10, wherein
the oil phase comprises a binder resin precursor formed of a modified polyester resin,
the aqueous medium comprises a dispersing agent, and
the electrostatic image developing toner is obtained by a method comprising:
dissolving, in the oil phase, a compound capable of elongating or crosslinking with the binder resin precursor;
dispersing, in the aqueous medium, the oil phase in which the compound has been dissolved, to obtain a dispersion liquid;
allowing the binder resin precursor and the compound to undergo a crosslinking reaction, an elongating reaction, or both, in the dispersion liquid; and
removing the organic solvent from the dispersion liquid.

15. The electrostatic image developing toner particles according to claim 11, wherein
the oil phase comprises a binder resin precursor formed of a modified polyester resin,
the aqueous medium comprises a dispersing agent, and
the electrostatic image developing toner is obtained by a method comprising:
dissolving, in the oil phase, a compound capable of elongating or crosslinking with the binder resin precursor;
dispersing, in the aqueous medium, the oil phase in which the compound has been dissolved, to obtain a dispersion liquid;
allowing the binder resin precursor and the compound to undergo a crosslinking reaction, an elongating reaction, or both, in the dispersion liquid; and
removing the organic solvent from the dispersion liquid.

16. The electrostatic imaging developing toner particles according to claim 1, wherein after the toner particles have been stored at 50° C. for 1.5 hours, the adhesive force between the toner particles is from 1.6 mN to 1.9 mN.

17. The electrostatic imaging developing toner particles according to claim 1, wherein the toner particles have a glass transition temperature of from 45° C. to 55° C.

18. The electrostatic imaging developing toner particles according to claim 1, wherein the crystalline polyester resin has a melting point of from 65° C. to 75° C.

19. The electrostatic imaging developing toner particles according to claim 5, wherein the binder resin precursor has a weight average molecular weight of from 1×10⁴ to 3×10⁵.

20. The electrostatic imaging developing toner particles according to claim 1, wherein the releasing agent is a wax having a melting point of from 50° C. to 120° C.
